(19) United States
(12) Patent Application Publication
(10) Pub. No.: US 2018/0346778 A1
(43) Pub. Date: Dec. 6, 2018

(54) TUNABLE ADHESIVE COMPOSITIONS AND METHODS

(71) Applicant: Caddis Adhesive Company, Inc., Boston, MA (US)

(72) Inventors: Elisha Long, Cohasset, MA (US); John C. Warner, Wilmington, MA (US); Justin Whitfield, Wilmington, MA (US); Bill Dorogy, Wilmington, MA (US); Frederick Richard Kearney, Wilmington, MA (US)

(21) Appl. No.: 15/994,660

(22) Filed: May 31, 2018

Related U.S. Application Data
(63) Continuation of application No. PCT/US2017/062619, filed on Nov. 20, 2017.
(60) Provisional application No. 62/424,081, filed on Nov. 18, 2016.
(60) Provisional application No. 62/457,606, filed on Feb. 10, 2017.

(51) Int. Cl. C09J 201/00; C09J 189/00; C09J 105/00; C09J 103/02

(52) U.S. Cl. CPC C09J 201/00; C09J 189/00; C09J 105/00; C09J 103/02; C09J 2400/283; C09J 2400/143; C09J 2400/163; C09J 2400/226; C09J 2400/123

(57) ABSTRACT

Disclosed are non-toxic adhesive compositions that are tunable for selective adhesion to an intended substrate under any number of conditions, including a fouled substrate. Methods of making and methods of using are also described.

### RELATED APPLICATIONS

This application is a continuation of PCT/US2017/062619, filed Nov. 20, 2017, which claims the benefit and priority of provisional application U.S. Ser. No. 62/424,081, filed Nov. 18, 2016 and U.S. Ser. No. 62/457,606, filed Feb. 10, 2017, the contents of each of which are herein incorporated by reference in their entirety.

### FIELD OF THE DISCLOSURE

The disclosure is directed to the fields of chemistry, biochemistry and tunable adhesive compositions, methods of making and methods of using the same.

### BACKGROUND

There have been long-felt but unmet needs in the art for a non-toxic adhesive that is tunable for selective adhesion to any substrate and in any environmental, manufacturing, or medical application, including enhanced adhesion to fouled surfaces. The disclosure provides a system and methods to solve these long-felt but unmet needs.

### SUMMARY

The disclosure provides an adhesive composition comprising, (a) a first component, wherein the first component (1) is water insoluble and (2) has a molecular weight of between 300 kDa and 1000 kDa, inclusive of the endpoints; (b) a second component, wherein the second component (1) is water insoluble and (2) has a molecular weight of between 20 kDa and 35 kDa, inclusive of the endpoints; and (c) a third component, wherein the third component (1) is water soluble and (2) has a molecular weight of between 1 Da and 19.9 kDa, inclusive of the endpoints; wherein each of the first component, the second component, and the third component is present in a ratio and wherein the ratio is tunable for selective adhesion to at least one substrate.

In certain embodiments of the compositions of the disclosure, the at least one substrate comprises an organic component. In certain embodiments, the organic component comprises a fiber, a resin, a polymer, a composite, a tissue or any combination thereof. In certain embodiments, the fiber comprises a plant protein. In certain embodiments, including those in which the fiber comprises a plant protein, the substrate comprises wood, paper, cloth, lignocellulose, or any combination thereof. In certain embodiments, the fiber comprises an animal protein. In certain embodiments, including those in which the fiber comprises an animal protein, the substrate comprises silk. In certain embodiments, the polymer comprises a plant polymer. In certain embodiments, including those in which the polymer comprises a plant polymer, the substrate comprises cellulose, starch, protein, DNA or any combination thereof. In certain embodiments, the polymer comprises an animal polymer. In certain embodiments, including those in which the polymer comprises an animal polymer, the substrate comprises wool, hair, fur, angora, cashmere, mohair, protein, keratin, DNA or any combination thereof. In certain embodiments, the tissue comprises a plant protein. In certain embodiments, including those in which the tissue comprises a plant tissue, the substrate comprises a tissue obtained, prepared, or derived from a mushroom, a tree, a tree or plant pulp, a lignocellulose or any combination thereof. In certain embodiments, the tissue comprises an animal protein. In certain embodiments, including those in which the tissue comprises an animal tissue, the substrate comprises leather. In certain embodiments, including those in which the tissue comprises an animal tissue, the tissue comprises any tissue of a human body. In certain embodiments, including those in which the tissue comprises an animal tissue, the tissue comprises any tissue of a non-human body. Exemplary non-human species of the disclosure include, but are not limited to vertebrates, invertebrates, cold-blooded species, warm-blooded species, birds, insects, reptiles, marsupials, amphibians, and mammals. Exemplary tissue of a human or non-human body include, but are not limited to skin, sensory organs (eyes and visual tissues; nose and olfactory tissues; ears and auditory tissues; skin and touch, temperature, vibration or pain sensing tissues; tongue, mouth, and taste tissues), nervous system tissues (brain, spinal cord, nerves (central and peripheral), ganglion, ganglia, neurons and neuroglia, and fluids surrounding same); immune system tissues (immune cells, spleen, lymph tissue and fluid, and bone marrow), muscle tissue (smooth, cardiac, skeletal, and fibers or cells of same); circulatory system (heart, vasculature, blood brain barrier, vessels, veins, and capillaries); respiratory system (lung tissue); digestive system (mouth, esophagus, stomach, intestines, colon); filtering systems (gills, blood brain barrier, kidneys, liver); urinary system; reproductive system; skeleton (bones, bone cells, skull, cartilage, joints), and endocrine system (pituitary, thyroid, and adrenal glands, pancreas, ovary, testis).

In certain embodiments of the compositions of the disclosure, the at least one substrate comprises an organic component. In certain embodiments, the organic component may be modified from its native (i.e. naturally-occurring) composition or structure. In certain embodiments, including those embodiments wherein the organic component comprises a protein or DNA molecule or polymer, the nucleic acid or amino acid sequence of the organic component may be modified to produce or enhance a desired characteristic compared to the native sequence of the protein or DNA molecule or polymer. In certain embodiments, protein or DNA molecules or polymers of the disclosure may be recombinant or chimeric. In certain embodiments, protein or DNA molecules or polymers of the disclosure are not naturally-occurring. In certain embodiments, the organic component comprises is chemically or physically modified to produce or enhance a desired characteristic compared to the native version of the component. In certain embodiments, the organic component is a composite of one or more components of the disclosure, the composite having a novel or enhanced characteristic when compared to the properties of any one of the single components contributing to the composite.

In certain embodiments of the compositions of the disclosure, the at least one substrate comprises an organic component. In certain embodiments, the organic component consists of carbon. In certain embodiments, the carbon is crystalline, polycrystalline, or amorphous. In certain embodiments, the organic component comprises a carbon nanostructure. In certain embodiments, the organic component comprises graphene.

In certain embodiments of the compositions of the disclosure, the at least one substrate comprises an inorganic component. In certain embodiments, the inorganic component comprises a metal, a stone, a crystal, a chemical compound, a glass, an alloy, a composite, a polymer or any combination thereof. In certain embodiments, the inorganic component comprises a metalloid. In certain embodiments, the metalloid comprises silicon, antimony or a derivative thereof. In certain embodiments, including those in which the inorganic component comprises a chemical compound, the chemical compound comprises silicon, boron and nitrogen. In certain embodiments, including those in which the inorganic component comprises a polymer, the polymer is not naturally-occurring. In certain embodiments, including those in which the inorganic component comprises a metal, the metal comprises an alkali metal, an alkaline earth metal, a lanthanoid, an actinoid, a transition metal, a post-transition metal, or any combination thereof. In certain embodiments, including those in which the inorganic component comprises stone, the stone comprises marble, granite, limestone, slate, onyx, agate, sandstone, obsidian, lava stone, travertine or any combination thereof. In certain embodiments, including those in which the inorganic component comprises stone, the stone comprises a composite material. In certain embodiments, including those in which the inorganic component comprises stone or the stone comprises a composite material, the substrate comprises a concrete. In certain embodiments, including those in which the inorganic component comprises crystal, the crystal comprises a quartz or a quartz composite. In certain embodiments, including those in which the crystal comprises a quartz or a quartz composite, the quartz or the quartz composite comprises silicon. In certain embodiments, the crystal comprises a calcium carbonate. In certain embodiments, including those in which the crystal comprises a calcium carbonate, the crystal comprises calcite.

In certain embodiments of the compositions of the disclosure, the at least one substrate comprises an inorganic component. In certain embodiments, the inorganic component is not naturally-occurring.

In certain embodiments of the compositions of the disclosure, the at least one substrate is dry.

In certain embodiments of the compositions of the disclosure, the at least one substrate is wet.

In certain embodiments of the compositions of the disclosure, the at least one substrate is fouled. In certain preferred embodiments, the substrate is fouled. In certain embodiments, the at least one substrate is wet. In certain embodiments, the at least one substrate is dry.

In certain embodiments of the compositions of the disclosure, the at least one substrate is submerged in a liquid. In certain embodiments, the substrate is fouled. In certain embodiments, the liquid is water. In certain embodiments, the liquid is seawater. In certain embodiments, the liquid is a biological fluid. Exemplary biological fluids of the disclosure include, but are not limited to, blood, serum, plasma, lymph fluid, cerebral spinal fluid, synovial fluid, urine, tears, sweat, plural effusion, pus or any other fluid found in vivo or extracted from a body. In certain embodiments, the liquid is a non-Neutonian fluid. Non-Neutonian fluids of the disclosure may exhibit non-Neutonian flow under certain conditions. Alternatively, or in addition, non-Neutonian fluids of the disclosure may exhibit non-Neutonian flow under all conditions. For example, blood plasma when part of whole blood may demonstrate non-Neutonian flow, however, blood plasma isolated from all other whole blood components may demonstrate Neutonian flow. Exemplary non-Neutonian fluids of the disclosure include, but are not limited to, lubricants, inks, synovial fluid, mucus, oil, gum, clay, paint (e.g. latex paint), colloidal suspensions, slurries (including cement slurry and paper pulp, emulsions, and some dispersions), syrups, ice, whole blood, silicone-based compositions (including silicone oil and silicone coatings), putty, gelatin gels, and Bingham plastics.

In certain embodiments of the compositions of the disclosure, the at least one substrate is a first substrate and a second substrate.

In certain embodiments of the compositions of the disclosure, the at least one substrate is a first substrate and a second substrate. In certain embodiments, a surface of the first substrate and a surface of the second substrate comprise an identical material. In certain embodiments, a surface of the first substrate and a surface of the second substrate comprise a material having a comparable value of one or more characteristic selected from the group consisting of a volume, a mass, a surface area, a dimension, a density, a concentration, a capacitance, a resistance, a magnetism, an inductance, a ductility, a reflectiveness, a fragility, a brittleness, a charge, a conductivity, an impedance, a fluidity, a hardness, an irradiance, a malleability, a permeability, a porosity, a plasticity, an elasticity, a deformability, a fibrosity, a solubility, a viscosity, a level of fouling, a level of degradation, a smoothness, a uniformity of composition, a uniformity of characteristic, and a composition.

In certain embodiments of the compositions of the disclosure, the at least one substrate is a first substrate and a second substrate. In certain embodiments, a surface of the first substrate and a surface of the second substrate do not comprise an identical material. In certain embodiments, a surface of the first substrate and a surface of the second substrate do not comprise a material having a comparable value of one or more characteristic selected from the group consisting of a volume, a mass, a surface area, a dimension, a density, a concentration, a capacitance, a resistance, a magnetism, an inductance, a ductility, a reflectiveness, a fragility, a brittleness, a charge, a conductivity, an impedance, a fluidity, a hardness, an irradiance, a malleability, a permeability, a porosity, a plasticity, an elasticity, a deformability, a fibrosity, a solubility, a viscosity, a level of fouling, a level of degradation, a smoothness, a uniformity of composition, a uniformity of characteristic, and a composition.

In certain embodiments of the compositions of the disclosure, the first component has a greater contribution to the ratio than either of the second component or the third component. In certain embodiments, the second component has a greater contribution to the ratio than the third component. In certain embodiments, the third component has a greater contribution to the ratio than the second component.

In certain embodiments of the compositions of the disclosure, the second component has a greater contribution to the ratio than either of the first component or the third component. In certain embodiments, the first component has a greater contribution to the ratio than the third component. In certain embodiments, the third component has a greater contribution to the ratio than the first component.

In certain embodiments of the compositions of the disclosure, the third component has a greater contribution to the ratio than either of the first component or the second component. In certain embodiments, the first component has a greater contribution to the ratio than the second component. In certain embodiments, the second component has a greater contribution to the ratio than the first component.

In certain embodiments of the compositions of the disclosure, the first component, the second component, and the third component contribute equally to the ratio.

In certain embodiments of the compositions of the disclosure, the first component is a kinetic modifier.

In certain embodiments of the compositions of the disclosure, the first component is a kinetic modifier. In certain embodiments of the compositions of the disclosure, the first component comprises a protein, a fiber, a resin, an extract, a distillate or a polymer. In certain embodiments, the first component comprises a soy protein, a rice protein, a wheat protein, a barley protein, an algal protein, a wood fiber, a wood flour, a cellulose fiber, a cellulose nanofiber, a cellulose nanofibril, a starch, a polysaccharide, a silk fiber, a silk fibroin, a chitin, a keratin or a chitosan. In certain embodiments, the first component comprises a soy protein.

In certain embodiments of the compositions of the disclosure, the second component is a thermodynamic modifier.

In certain embodiments of the compositions of the disclosure, the second component is a thermodynamic modifier. In certain embodiments of the compositions of the disclosure, the second component comprises a protein, a distillate, a resin, a starch, a polysaccharide or an extract. In certain embodiments, the second component comprises a casein protein, a K-casein protein, a chitosan, a chitin, a keratin or a sericin protein. In certain embodiments, the second component comprises a casein protein.

In certain embodiments of the compositions of the disclosure, the third component is an interstitial modifier.

In certain embodiments of the compositions of the disclosure, the third component is an interstitial modifier. In certain embodiments of the compositions of the disclosure, the third component comprises a protein, an enzyme, a hydrosylate, a distillate or an extract. In certain embodiments, the third component comprises a soy hydrosylate, a yeast extract, a yeast hydrosylate, a poly(vinyl) alcohol, a polyol, a starch, an alginate or a crosslinker. In certain embodiments, the crosslinker comprises an enzyme. In certain embodiments, the enzyme comprises a transglutaminase. In certain embodiments, the transglutaminase is isolated, purified, or derived from a microbial transglutaminase. In certain embodiments, the third component comprises a starch.

In certain embodiments of the compositions of the disclosure, the ratio of the first component:second component:third component is 6:6:1.

In certain embodiments of the compositions of the disclosure, the ratio of the first component:second component:third component is 6:6:1. In certain embodiments, the first component comprises a soy protein, wherein the second component comprises a casein protein, and wherein the third component comprises a starch.

In certain embodiments of the compositions of the disclosure, the ratio of the first component:second component:third component is 4:4:5.

In certain embodiments of the compositions of the disclosure, the ratio of the first component:second component:third component is 4:4:5. In certain embodiments, the first component comprises a rice protein, wherein the second component comprises a casein protein, and wherein the third component comprises a starch hydrosylate. In certain embodiments, the at least one substrate comprises paper.

In certain embodiments of the compositions of the disclosure, the ratio of the first component:second component:third component is 4:4:5. In certain embodiments, the first component comprises a soy protein, wherein the second component comprises a casein protein, and wherein the third component comprises a starch hydrosylate. In certain embodiments, the at least one substrate comprises wood.

### BRIEF DESCRIPTION OF THE DRAWINGS

FIG. 1 is a table providing maximum force data of from the sheer test for adhesive formulations using Tin-Free Steel as a substrate (Example 1).

FIG. 2 is a graph depicting maximum force data of from the sheer test for adhesive formulations using Tin-Free Steel as a substrate (Example 1).

FIG. 3 is a table providing maximum force data of from the sheer test for adhesive formulations using Kraft Paper as a substrate (Example 1).

FIG. 4 is a graph depicting maximum force data of from the sheer test for adhesive formulations using Kraft Paper as a substrate (Example 1).

FIG. 5 is a graph comparing the maximum force necessary to sheer Kraft Paper under wet and dry conditions for adhesive formulations (Example 1).

FIG. 6 is a graph comparing the energy required to break adhesion to Kraft Paper under wet and dry conditions for adhesive formulations (Example 1).

FIG. 7 is a graph comparing the maximum force necessary to sheer Kraft Paper under wet and dry conditions for adhesive formulations (Example 1).

FIG. 8 is a graph comparing the energy required to break adhesion to Kraft Paper under wet and dry conditions for adhesive formulations (Example 1).

FIG. 9 is a graph comparing the maximum force necessary to sheer wood veneer under wet and dry conditions for adhesive formulations (Example 1).

FIG. 10 is a graph comparing the energy required to break adhesion to wood veneer under wet and dry conditions for adhesive formulations (Example 1).

FIG. 11 is a graph comparing the maximum force necessary to sheer Kraft Paper under wet and dry conditions for adhesive formulations (Example 1).

FIG. 12 is a graph comparing the energy required to break adhesion to Kraft Paper under wet and dry conditions for adhesive formulations (Example 1).

FIG. 13 is a series of photographs depicting the Lap Shear Test Specimen Procedure performed in Example 1.

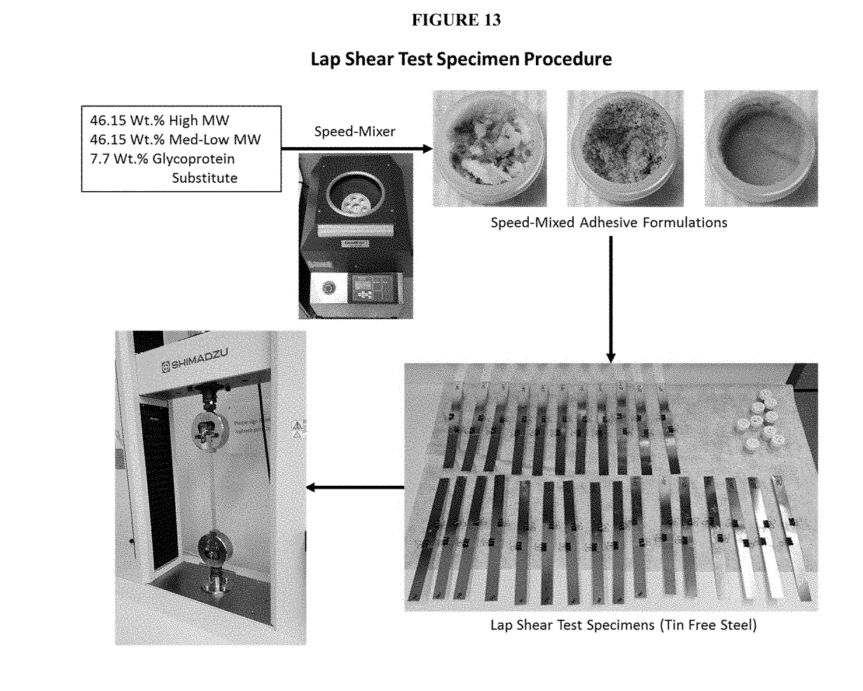

FIG. 14 is a graph depicting maximum force data of from the sheer test shown in FIG. 13 for adhesive formulations using Tin-Free Steel (TFS) as a substrate (Example 1).

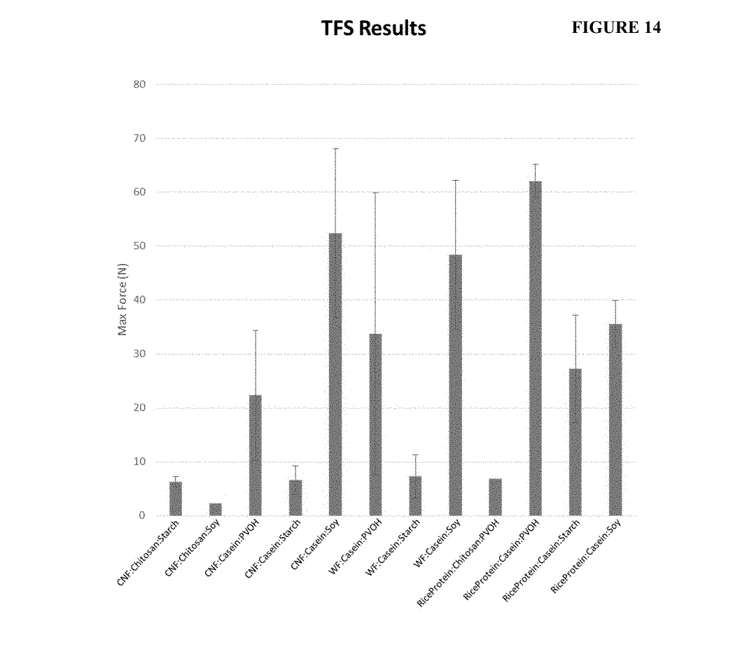

FIG. 15 is a graph depicting maximum force data of from the sheer test shown in FIG. 13 for adhesive formulations using Kraft paper as a substrate (Example 1). Of note, the Kraft paper ripped during the testing of the formulation comprising Rice Protein, Casein and Soy and the result shown here may underestimate this formulation's performance. Accordingly, the results of this test for the formulation comprising Rice Protein, Casein and Soy may be interpreted as this formulation having a maximum force data of at least 155 N. FIG. 3 provides the specific data points for these formulations. For example, the formulation comprising Rice Protein, Casein and Soy may also be referred to herein as (“252-23F”).

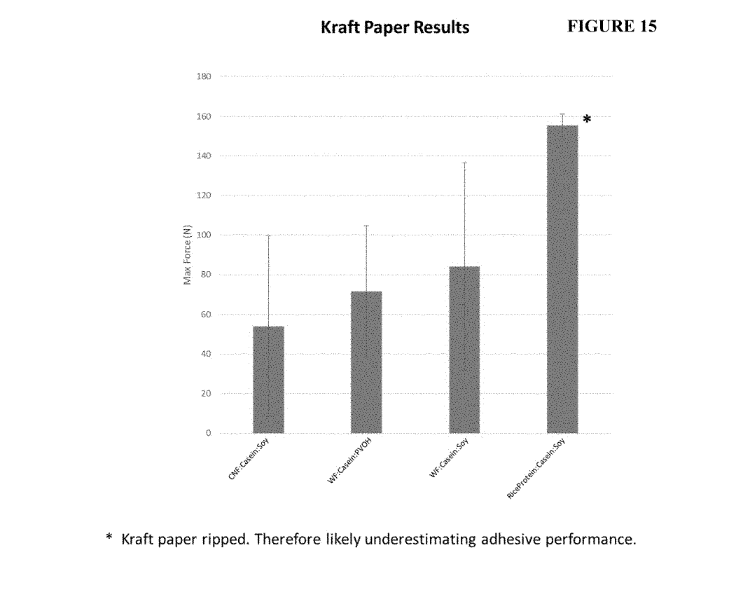

FIG. 16 is a schematic diagram depicting the three components of the adhesive compositions of the disclosure: a Kinetic Modifier, a Thermodynamic Modifier and an Interstitial Modifier. By adjusting and balancing a ratio of these three components, the properties of an adhesive composition can be tuned and adjusted to suit various materials (substrates) and environmental conditions (wet, dry, clean or fouled surfaces). Virtually any task requiring an adhesive can be accomplished using this technology.

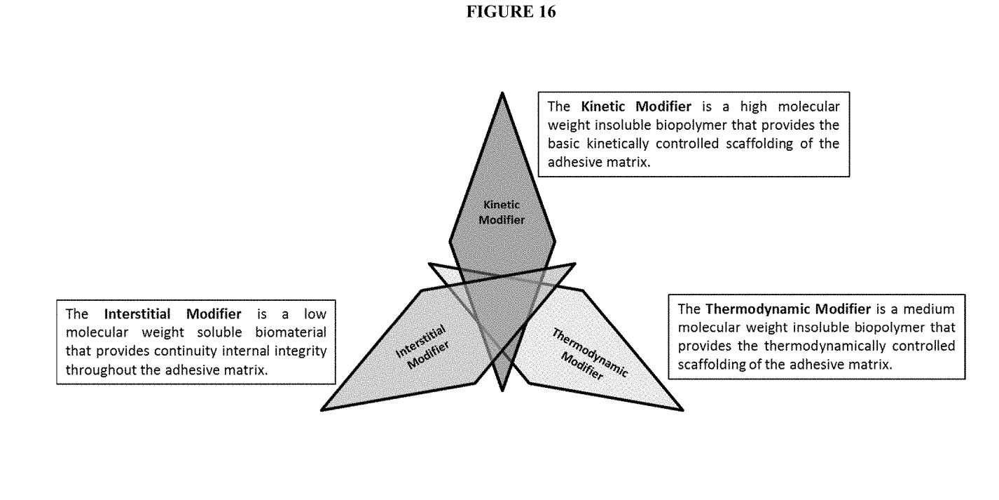

### DETAILED DESCRIPTION

The disclosure provides a non-toxic adhesive composition that is tunable for selective adhesion to any substrate under any condition. Intended substrates may be dry, wet, or submerged in a fluid. The adhesive compositions of the disclosure preferentially bind to fouled surfaces. These properties provide multiple superior properties over existing adhesives. For example, the adhesive compositions of the disclosure may be manufactured and applied to any substrate at ambient temperature. As used herein ambient temperature may describe any temperature outside or inside that is above freezing and below boiling at any given altitude.

The disclosure provides an adhesive composition comprising, (a) a first component, wherein the first component (1) is water insoluble and (2) has a molecular weight of between 300 kDa and 1000 kDa, inclusive of the endpoints; (b) a second component, wherein the second component (1) is water insoluble and (2) has a molecular weight of between 20 kDa and 35 kDa, inclusive of the endpoints; and (c) a third component, wherein the third component (1) is water soluble and (2) has a molecular weight of between 1 Da and 19.9 kDa, inclusive of the endpoints; wherein each of the first component, the second component, and the third component is present in a ratio and wherein the ratio is tunable for selective adhesion to at least one substrate.

### Components

The disclosure provides an adhesive composition comprising, (a) a first component, wherein the first component (1) is water insoluble and (2) has a molecular weight of between 300 kDa and 1000 kDa, inclusive of the endpoints; (b) a second component, wherein the second component (1) is water insoluble and (2) has a molecular weight of between 20 kDa and 35 kDa, inclusive of the endpoints; and (c) a third component, wherein the third component (1) is water soluble and (2) has a molecular weight of between 1 Da and 19.9 kDa, inclusive of the endpoints.

The molecular weight of any one or more component of an adhesive composition of the disclosure may fall within the ranges provided above.

The “high molecular weight” component, while comprising molecular weight of between 300 kDa and 1000 kDa, inclusive of the endpoints, may have a molecular weight that extend beyond this stated range at either the minimum or maximum value by 1, 5, 10, 50, 100 or any kilo Dalton molecular weight in between.

The “middle molecular weight” component, while comprising molecular weight of between 20 kDa and 35 kDa, inclusive of the endpoints, may have a molecular weight that extend beyond this stated range at either the minimum or maximum value by 0.1, 0.5, 1, 2, 3, 4, 5, 6, 7, 8, 9, 10 or any kilo Dalton molecular weight in between.

The “low molecular weight” component, while comprising molecular weight of between 1 Da and 19.9 kDa, inclusive of the endpoints, may have a molecular weight that extend beyond this stated range at either the minimum or maximum value by 0.1, 0.5, 1, 2, 3, 4, 5, 6, 7, 8, 9, 10, 20, 30, 40, 50, 60, 70, 80, 90, 100, 500, 1000 or any Dalton molecular weight in between.

Exemplary component s of the disclosure, may include but are not limited to those provided in Table 2 of Example 1.

### Tunable Ratios

The adhesive compositions of the disclosure comprise three components: (a) a first component, wherein the first component (1) is water insoluble and (2) has a molecular weight of between 300 kDa and 1000 kDa, inclusive of the endpoints; (b) a second component, wherein the second component (1) is water insoluble and (2) has a molecular weight of between 20 kDa and 35 kDa, inclusive of the endpoints; and (c) a third component, wherein the third component (1) is water soluble and (2) has a molecular weight of between 1 Da and 19.9 kDa, inclusive of the endpoints. A superior property of the adhesive compositions of the disclosure is the tunable character of the adhesives to enable selective adhesion to any substrate under any condition.

The first component of the adhesive is a kinetic modifier. The second component of the adhesive is a thermodynamic modifier. The third component of the adhesive is an interstitial modifier. By varying the relative contributions of each of these three components, the following properties of the resultant adhesive composition may be optimized for selective adhesion to an intended substrate: reaction rate, mechanical strength, entanglement and specific noncovalent interactions. For example, as a kinetic modifier, a change to the relative contribution of the first component of the adhesive relative to the other two components may result in a change in the reaction rate (among changes to the other three properties). Moreover, as a thermodynamic modifier, a change to the relative contribution of the second component of the adhesive relative to the other two components may result in a change in the mechanical strength (among changes to the other three properties). As an interstitial modifier, a change to the relative contribution of the third component of the adhesive relative to the other two components may result in a change in the entanglement and/or specific noncovalent interactions (among changes to the other properties).

In certain embodiments, the adhesive compositions of the disclosure may be tuned to selective adhere two highly fibrous, water permeable substrates as follows: Increase contribution of component 1 and component 2 compared to the contribution of component 3. Tuning the adhesive in this way may improve performance by adding mechanical strength and limiting entanglement. In this embodiment, the components offer good non-covalent interactions to compete with substrate interactions. The reaction rate is balanced to be slow enough to offer efficient penetration while allowing practical setting.

In certain embodiments, the adhesive compositions of the disclosure may be tuned to selective adhere two comparatively smooth, low permeability substrates as follows: Decrease the contribution of component 1 relative to the contributions of both components 2 and 3. Tuning the adhesive in this way may improve performance by adding mechanic strength while increasing entanglement. In the absence of a fibrous penetrable matrix, non-covalent interactions can be maximized and the reaction rate can be accelerated.

Table 1 provides an exemplary listing of contemplated ratios for the relative contributions of each of the components of the adhesive compositions of the disclosure. While the ratios listed in Table 1 provide a maximal spread of 1:10 between any two components of the adhesive compositions of the disclosure, using the pattern demonstrated below, further differences are contemplated. For example, the adhesive compositions of the disclosure may have a maximal spread of the ratio of any two components of 1:15, 1:20, 1:25, 1:30, 1:35, 1:40, 1;45. 1:50, 1:55, 1:60, 1:70, 1:75, 1:80, 1:85, 1:90, 1:95, 1:100, 1:150, 1:200, 1:250, 1:300, 1:350, 1:400, 1:450, 1:500 or any ratio spread in between.

TABLE 1

| Ratio | Component | | |
|---|---|---|---|
| Contribution | Component | Component | Component |
| # | 1 | 2 | 3 |
| 1 | 1 | 1 | 1 |
| 2 | 2 | 1 | 1 |
| 3 | 1 | 2 | 1 |
| 4 | 1 | 1 | 2 |
| 5 | 1 | 2 | 2 |
| 6 | 2 | 1 | 2 |
| 7 | 2 | 2 | 1 |
| 8 | 3 | 3 | 2 |
| 9 | 3 | 3 | 1 |
| 10 | 3 | 2 | 3 |
| 11 | 3 | 2 | 2 |
| 12 | 3 | 2 | 1 |
| 13 | 3 | 1 | 3 |
| 14 | 3 | 1 | 2 |
| 15 | 3 | 1 | 1 |
| 16 | 2 | 3 | 3 |
| 17 | 1 | 3 | 3 |
| 18 | 3 | 3 | 2 |
| 19 | 2 | 3 | 2 |
| 20 | 1 | 3 | 2 |
| 21 | 3 | 3 | 1 |
| 22 | 2 | 3 | 1 |
| 23 | 1 | 3 | 1 |
| 24 | 2 | 3 | 3 |
| 25 | 1 | 3 | 3 |
| 26 | 3 | 2 | 3 |
| 27 | 2 | 2 | 3 |
| 28 | 1 | 2 | 3 |
| 29 | 3 | 1 | 3 |
| 30 | 2 | 1 | 3 |
| 31 | 1 | 1 | 3 |
| 32 | 4 | 4 | 3 |
| 33 | 4 | 4 | 2 |
| 34 | 4 | 4 | 1 |
| 35 | 4 | 3 | 4 |
| 36 | 4 | 3 | 3 |
| 37 | 4 | 3 | 2 |
| 38 | 4 | 3 | 1 |
| 39 | 4 | 2 | 4 |
| 40 | 4 | 2 | 3 |
| 41 | 4 | 2 | 2 |
| 42 | 4 | 2 | 1 |
| 43 | 4 | 1 | 4 |
| 44 | 4 | 1 | 3 |
| 45 | 4 | 1 | 2 |
| 46 | 4 | 1 | 1 |
| 47 | 3 | 4 | 4 |
| 48 | 2 | 4 | 4 |
| 49 | 1 | 4 | 4 |
| 50 | 4 | 4 | 3 |
| 51 | 3 | 4 | 3 |
| 52 | 2 | 4 | 3 |
| 53 | 1 | 4 | 3 |
| 54 | 4 | 4 | 2 |
| 55 | 3 | 4 | 2 |
| 56 | 2 | 4 | 2 |
| 57 | 1 | 4 | 2 |
| 58 | 4 | 4 | 1 |
| 59 | 3 | 4 | 1 |
| 60 | 2 | 4 | 1 |
| 61 | 1 | 4 | 1 |
| 62 | 4 | 3 | 4 |
| 63 | 4 | 2 | 4 |
| 64 | 4 | 1 | 4 |
| 65 | 3 | 4 | 4 |
| 66 | 3 | 3 | 4 |
| 67 | 3 | 2 | 4 |
| 68 | 3 | 1 | 4 |
| 69 | 2 | 4 | 4 |
| 70 | 2 | 3 | 4 |
| 71 | 2 | 2 | 4 |
| 72 | 2 | 1 | 4 |
| 73 | 1 | 4 | 4 |
| 74 | 1 | 3 | 4 |
| 75 | 1 | 2 | 4 |
| 76 | 1 | 1 | 4 |
| 77 | 5 | 5 | 4 |
| 78 | 5 | 5 | 3 |
| 79 | 5 | 5 | 2 |
| 80 | 5 | 5 | 1 |
| 81 | 5 | 4 | 5 |
| 82 | 5 | 4 | 4 |
| 83 | 5 | 4 | 3 |
| 84 | 5 | 4 | 2 |
| 85 | 5 | 4 | 1 |
| 86 | 5 | 3 | 5 |
| 87 | 5 | 3 | 4 |
| 88 | 5 | 3 | 3 |
| 89 | 5 | 3 | 2 |
| 90 | 5 | 3 | 1 |
| 91 | 5 | 2 | 5 |
| 92 | 5 | 2 | 4 |
| 93 | 5 | 2 | 3 |
| 94 | 5 | 2 | 2 |
| 95 | 5 | 2 | 1 |
| 96 | 5 | 1 | 5 |
| 97 | 5 | 1 | 4 |
| 98 | 5 | 1 | 3 |
| 99 | 5 | 1 | 2 |
| 100 | 5 | 1 | 1 |
| 101 | 4 | 5 | 5 |
| 102 | 3 | 5 | 5 |
| 103 | 2 | 5 | 5 |
| 104 | 1 | 5 | 5 |
| 105 | 5 | 5 | 4 |
| 106 | 4 | 5 | 4 |
| 107 | 3 | 5 | 4 |
| 108 | 2 | 5 | 4 |
| 109 | 1 | 5 | 4 |
| 110 | 5 | 5 | 3 |
| 111 | 4 | 5 | 3 |
| 112 | 3 | 5 | 3 |
| 113 | 2 | 5 | 3 |
| 114 | 1 | 5 | 3 |
| 115 | 5 | 5 | 2 |
| 116 | 4 | 5 | 2 |
| 117 | 3 | 5 | 2 |
| 118 | 2 | 5 | 2 |
| 119 | 1 | 5 | 2 |
| 120 | 5 | 5 | 1 |
| 121 | 4 | 5 | 1 |
| 122 | 3 | 5 | 1 |
| 123 | 2 | 5 | 1 |
| 124 | 1 | 5 | 1 |
| 125 | 5 | 4 | 5 |
| 126 | 5 | 3 | 5 |
| 127 | 5 | 2 | 5 |
| 128 | 5 | 1 | 5 |
| 129 | 4 | 5 | 5 |
| 130 | 4 | 4 | 5 |
| 131 | 4 | 3 | 5 |
| 132 | 4 | 2 | 5 |
| 133 | 4 | 1 | 5 |
| 134 | 3 | 5 | 5 |
| 135 | 3 | 4 | 5 |
| 136 | 3 | 3 | 5 |
| 137 | 3 | 2 | 5 |
| 138 | 3 | 1 | 5 |
| 139 | 2 | 5 | 5 |
| 140 | 2 | 4 | 5 |
| 141 | 2 | 3 | 5 |
| 142 | 2 | 2 | 5 |
| 143 | 2 | 1 | 5 |
| 144 | 1 | 5 | 5 |
| 145 | 1 | 4 | 5 |
| 146 | 1 | 3 | 5 |
| 147 | 1 | 2 | 5 |
| 148 | 1 | 1 | 5 |
| 149 | 6 | 6 | 5 |
| 150 | 6 | 6 | 4 |
| 151 | 6 | 6 | 3 |
| 152 | 6 | 6 | 2 |
| 153 | 6 | 6 | 1 |
| 154 | 6 | 5 | 6 |
| 155 | 6 | 5 | 5 |
| 156 | 6 | 5 | 4 |
| 157 | 6 | 5 | 3 |
| 158 | 6 | 5 | 2 |
| 159 | 6 | 5 | 1 |
| 160 | 6 | 4 | 6 |
| 161 | 6 | 4 | 5 |
| 162 | 6 | 4 | 4 |
| 163 | 6 | 4 | 3 |
| 164 | 6 | 4 | 2 |
| 165 | 6 | 4 | 1 |
| 166 | 6 | 3 | 6 |
| 167 | 6 | 3 | 5 |
| 168 | 6 | 3 | 4 |
| 169 | 6 | 3 | 3 |
| 170 | 6 | 3 | 2 |
| 171 | 6 | 3 | 1 |
| 172 | 6 | 2 | 6 |
| 173 | 6 | 2 | 5 |
| 174 | 6 | 2 | 4 |
| 175 | 6 | 2 | 3 |
| 176 | 6 | 2 | 2 |
| 177 | 6 | 2 | 1 |
| 178 | 6 | 1 | 6 |
| 179 | 6 | 1 | 5 |
| 180 | 6 | 1 | 4 |
| 181 | 6 | 1 | 3 |
| 182 | 6 | 1 | 2 |
| 183 | 6 | 1 | 1 |
| 184 | 5 | 6 | 6 |
| 185 | 4 | 6 | 6 |
| 186 | 3 | 6 | 6 |
| 187 | 2 | 6 | 6 |
| 188 | 1 | 6 | 6 |
| 189 | 6 | 6 | 5 |
| 190 | 5 | 6 | 5 |
| 191 | 4 | 6 | 5 |
| 192 | 3 | 6 | 5 |
| 193 | 2 | 6 | 5 |
| 194 | 1 | 6 | 5 |
| 195 | 6 | 6 | 4 |
| 196 | 5 | 6 | 4 |
| 197 | 4 | 6 | 4 |
| 198 | 3 | 6 | 4 |
| 199 | 2 | 6 | 4 |
| 200 | 1 | 6 | 4 |
| 201 | 6 | 6 | 3 |
| 202 | 5 | 6 | 3 |
| 203 | 4 | 6 | 3 |
| 204 | 3 | 6 | 3 |
| 205 | 2 | 6 | 3 |
| 206 | 1 | 6 | 3 |
| 207 | 6 | 6 | 2 |
| 208 | 5 | 6 | 2 |
| 209 | 4 | 6 | 2 |
| 210 | 3 | 6 | 2 |
| 211 | 2 | 6 | 2 |
| 212 | 1 | 6 | 2 |
| 213 | 6 | 6 | 1 |
| 214 | 5 | 6 | 1 |
| 215 | 4 | 6 | 1 |
| 216 | 3 | 6 | 1 |
| 217 | 2 | 6 | 1 |
| 218 | 1 | 6 | 1 |
| 219 | 6 | 5 | 6 |
| 220 | 6 | 4 | 6 |
| 221 | 6 | 3 | 6 |
| 222 | 6 | 2 | 6 |
| 223 | 6 | 1 | 6 |
| 224 | 5 | 6 | 6 |
| 225 | 5 | 5 | 6 |
| 226 | 5 | 4 | 6 |
| 227 | 5 | 3 | 6 |
| 228 | 5 | 2 | 6 |
| 229 | 5 | 1 | 6 |
| 230 | 4 | 6 | 6 |
| 231 | 4 | 5 | 6 |
| 232 | 4 | 4 | 6 |
| 233 | 4 | 3 | 6 |
| 234 | 4 | 2 | 6 |
| 235 | 4 | 1 | 6 |
| 236 | 3 | 6 | 6 |
| 237 | 3 | 5 | 6 |
| 238 | 3 | 4 | 6 |
| 239 | 3 | 3 | 6 |
| 240 | 3 | 2 | 6 |
| 241 | 3 | 1 | 6 |
| 242 | 2 | 6 | 6 |
| 243 | 2 | 5 | 6 |
| 244 | 2 | 4 | 6 |
| 245 | 2 | 3 | 6 |
| 246 | 2 | 2 | 6 |
| 247 | 2 | 1 | 6 |
| 248 | 1 | 6 | 6 |
| 249 | 1 | 5 | 6 |
| 250 | 1 | 4 | 6 |
| 251 | 1 | 3 | 6 |
| 252 | 1 | 2 | 6 |
| 253 | 1 | 1 | 6 |
| 254 | 7 | 7 | 6 |
| 255 | 7 | 7 | 5 |
| 256 | 7 | 7 | 4 |
| 257 | 7 | 7 | 3 |
| 258 | 7 | 7 | 2 |
| 259 | 7 | 7 | 1 |
| 260 | 7 | 6 | 7 |
| 261 | 7 | 6 | 6 |
| 262 | 7 | 6 | 5 |
| 263 | 7 | 6 | 4 |
| 264 | 7 | 6 | 3 |
| 265 | 7 | 6 | 2 |
| 266 | 7 | 6 | 1 |
| 267 | 7 | 5 | 7 |
| 268 | 7 | 5 | 6 |
| 269 | 7 | 5 | 5 |
| 270 | 7 | 5 | 4 |
| 271 | 7 | 5 | 3 |
| 272 | 7 | 5 | 2 |
| 273 | 7 | 5 | 1 |
| 274 | 7 | 4 | 7 |
| 275 | 7 | 4 | 6 |
| 276 | 7 | 4 | 5 |
| 277 | 7 | 4 | 4 |
| 278 | 7 | 4 | 3 |
| 279 | 7 | 4 | 2 |
| 280 | 7 | 4 | 1 |
| 281 | 7 | 3 | 7 |
| 282 | 7 | 3 | 6 |
| 283 | 7 | 3 | 5 |
| 284 | 7 | 3 | 4 |
| 285 | 7 | 3 | 3 |
| 286 | 7 | 3 | 2 |
| 287 | 7 | 3 | 1 |
| 288 | 7 | 2 | 7 |
| 289 | 7 | 2 | 6 |
| 290 | 7 | 2 | 5 |
| 291 | 7 | 2 | 4 |
| 292 | 7 | 2 | 3 |
| 293 | 7 | 2 | 2 |
| 294 | 7 | 2 | 1 |
| 295 | 7 | 1 | 7 |
| 296 | 7 | 1 | 6 |
| 297 | 7 | 1 | 5 |
| 298 | 7 | 1 | 4 |
| 299 | 7 | 1 | 3 |
| 300 | 7 | 1 | 2 |
| 301 | 7 | 1 | 1 |
| 302 | 6 | 7 | 7 |
| 303 | 5 | 7 | 7 |
| 304 | 4 | 7 | 7 |
| 305 | 3 | 7 | 7 |
| 306 | 2 | 7 | 7 |
| 307 | 1 | 7 | 7 |
| 308 | 7 | 7 | 6 |
| 309 | 6 | 7 | 6 |
| 310 | 5 | 7 | 6 |
| 311 | 4 | 7 | 6 |
| 312 | 3 | 7 | 6 |
| 313 | 2 | 7 | 6 |
| 314 | 1 | 7 | 6 |
| 315 | 7 | 7 | 5 |
| 316 | 6 | 7 | 5 |
| 317 | 5 | 7 | 5 |
| 318 | 4 | 7 | 5 |
| 319 | 3 | 7 | 5 |
| 320 | 2 | 7 | 5 |
| 321 | 1 | 7 | 5 |
| 322 | 7 | 7 | 4 |
| 323 | 6 | 7 | 4 |
| 324 | 5 | 7 | 4 |
| 325 | 4 | 7 | 4 |
| 326 | 3 | 7 | 4 |
| 327 | 2 | 7 | 4 |
| 328 | 1 | 7 | 4 |
| 329 | 7 | 7 | 3 |
| 340 | 6 | 7 | 3 |
| 341 | 5 | 7 | 3 |
| 342 | 4 | 7 | 3 |
| 343 | 3 | 7 | 3 |
| 344 | 2 | 7 | 3 |
| 345 | 1 | 7 | 3 |
| 346 | 7 | 7 | 2 |
| 347 | 6 | 7 | 2 |
| 348 | 5 | 7 | 2 |
| 349 | 4 | 7 | 2 |
| 350 | 3 | 7 | 2 |
| 351 | 2 | 7 | 2 |
| 352 | 1 | 7 | 2 |
| 353 | 7 | 7 | 1 |
| 354 | 6 | 7 | 1 |
| 355 | 5 | 7 | 1 |
| 356 | 4 | 7 | 1 |
| 357 | 3 | 7 | 1 |
| 358 | 2 | 7 | 1 |
| 359 | 1 | 7 | 1 |
| 360 | 7 | 6 | 7 |
| 361 | 7 | 5 | 7 |
| 362 | 7 | 4 | 7 |
| 363 | 7 | 3 | 7 |
| 364 | 7 | 2 | 7 |
| 365 | 7 | 1 | 7 |
| 366 | 6 | 7 | 7 |
| 367 | 6 | 6 | 7 |
| 368 | 6 | 5 | 7 |
| 369 | 6 | 4 | 7 |
| 370 | 6 | 3 | 7 |
| 371 | 6 | 2 | 7 |
| 372 | 6 | 1 | 7 |
| 373 | 5 | 7 | 7 |
| 374 | 5 | 6 | 7 |
| 375 | 5 | 5 | 7 |
| 376 | 5 | 4 | 7 |
| 377 | 5 | 3 | 7 |
| 378 | 5 | 2 | 7 |
| 379 | 5 | 1 | 7 |
| 380 | 4 | 7 | 7 |
| 381 | 4 | 6 | 7 |
| 382 | 4 | 5 | 7 |
| 383 | 4 | 4 | 7 |
| 384 | 4 | 3 | 7 |
| 385 | 4 | 2 | 7 |
| 386 | 4 | 1 | 7 |
| 387 | 3 | 7 | 7 |
| 388 | 3 | 6 | 7 |
| 389 | 3 | 5 | 7 |
| 390 | 3 | 4 | 7 |
| 391 | 3 | 3 | 7 |
| 392 | 3 | 2 | 7 |
| 393 | 3 | 1 | 7 |
| 394 | 2 | 7 | 7 |
| 395 | 2 | 6 | 7 |
| 396 | 2 | 5 | 7 |
| 397 | 2 | 4 | 7 |
| 398 | 2 | 3 | 7 |
| 399 | 2 | 2 | 7 |
| 400 | 2 | 1 | 7 |
| 401 | 1 | 7 | 7 |
| 402 | 1 | 6 | 7 |
| 403 | 1 | 5 | 7 |
| 404 | 1 | 4 | 7 |
| 405 | 1 | 3 | 7 |
| 406 | 1 | 2 | 7 |
| 407 | 1 | 1 | 7 |
| 408 | 8 | 8 | 7 |
| 409 | 8 | 8 | 6 |
| 410 | 8 | 8 | 5 |
| 411 | 8 | 8 | 4 |
| 412 | 8 | 8 | 3 |
| 413 | 8 | 8 | 2 |
| 414 | 8 | 8 | 1 |
| 415 | 8 | 7 | 8 |
| 416 | 8 | 7 | 7 |
| 417 | 8 | 7 | 6 |
| 418 | 8 | 7 | 5 |
| 419 | 8 | 7 | 4 |
| 420 | 8 | 7 | 3 |
| 421 | 8 | 7 | 2 |
| 422 | 8 | 7 | 1 |
| 423 | 8 | 6 | 8 |
| 424 | 8 | 6 | 7 |
| 425 | 8 | 6 | 6 |
| 426 | 8 | 6 | 5 |
| 427 | 8 | 6 | 4 |
| 428 | 8 | 6 | 3 |
| 429 | 8 | 6 | 2 |
| 430 | 8 | 6 | 1 |
| 431 | 8 | 5 | 8 |
| 432 | 8 | 5 | 7 |
| 433 | 8 | 5 | 6 |
| 434 | 8 | 5 | 5 |
| 435 | 8 | 5 | 4 |
| 436 | 8 | 5 | 3 |
| 437 | 8 | 5 | 2 |
| 438 | 8 | 5 | 1 |
| 439 | 8 | 4 | 8 |
| 440 | 8 | 4 | 7 |
| 441 | 8 | 4 | 6 |
| 442 | 8 | 4 | 5 |
| 443 | 8 | 4 | 4 |
| 444 | 8 | 4 | 3 |
| 445 | 8 | 4 | 2 |
| 446 | 8 | 4 | 1 |
| 447 | 8 | 3 | 8 |
| 448 | 8 | 3 | 7 |
| 449 | 8 | 3 | 6 |
| 450 | 8 | 3 | 5 |
| 451 | 8 | 3 | 4 |
| 452 | 8 | 3 | 3 |
| 453 | 8 | 3 | 2 |
| 454 | 8 | 3 | 1 |
| 455 | 8 | 2 | 8 |
| 456 | 8 | 2 | 7 |
| 457 | 8 | 2 | 6 |
| 458 | 8 | 2 | 5 |
| 459 | 8 | 2 | 4 |
| 460 | 8 | 2 | 3 |
| 461 | 8 | 2 | 2 |
| 462 | 8 | 2 | 1 |
| 463 | 8 | 1 | 8 |
| 464 | 8 | 1 | 7 |
| 465 | 8 | 1 | 6 |
| 466 | 8 | 1 | 5 |
| 467 | 8 | 1 | 4 |
| 468 | 8 | 1 | 3 |
| 469 | 8 | 1 | 2 |
| 470 | 8 | 1 | 1 |
| 471 | 7 | 8 | 8 |
| 472 | 6 | 8 | 8 |
| 473 | 5 | 8 | 8 |
| 474 | 4 | 8 | 8 |
| 475 | 3 | 8 | 8 |
| 476 | 2 | 8 | 8 |
| 477 | 1 | 8 | 8 |
| 478 | 8 | 8 | 7 |
| 479 | 7 | 8 | 7 |
| 480 | 6 | 8 | 7 |
| 481 | 5 | 8 | 7 |
| 482 | 4 | 8 | 7 |
| 483 | 3 | 8 | 7 |
| 484 | 2 | 8 | 7 |
| 485 | 1 | 8 | 7 |
| 486 | 8 | 8 | 6 |
| 487 | 7 | 8 | 6 |
| 488 | 6 | 8 | 6 |
| 489 | 5 | 8 | 6 |
| 490 | 4 | 8 | 6 |
| 491 | 3 | 8 | 6 |
| 492 | 2 | 8 | 6 |
| 493 | 1 | 8 | 6 |
| 494 | 8 | 8 | 5 |
| 495 | 7 | 8 | 5 |
| 496 | 6 | 8 | 5 |
| 497 | 5 | 8 | 5 |
| 498 | 4 | 8 | 5 |
| 499 | 3 | 8 | 5 |
| 500 | 2 | 8 | 5 |
| 501 | 1 | 8 | 5 |
| 502 | 8 | 8 | 4 |
| 503 | 7 | 8 | 4 |
| 504 | 6 | 8 | 4 |
| 505 | 5 | 8 | 4 |
| 506 | 4 | 8 | 4 |
| 507 | 3 | 8 | 4 |
| 508 | 2 | 8 | 4 |
| 509 | 1 | 8 | 4 |
| 510 | 8 | 8 | 3 |
| 511 | 7 | 8 | 3 |
| 512 | 6 | 8 | 3 |
| 513 | 5 | 8 | 3 |
| 514 | 4 | 8 | 3 |
| 515 | 3 | 8 | 3 |
| 516 | 2 | 8 | 3 |
| 517 | 1 | 8 | 3 |
| 518 | 8 | 8 | 2 |
| 519 | 7 | 8 | 2 |
| 520 | 6 | 8 | 2 |
| 521 | 5 | 8 | 2 |
| 522 | 4 | 8 | 2 |
| 523 | 3 | 8 | 2 |
| 524 | 2 | 8 | 2 |
| 525 | 1 | 8 | 2 |
| 526 | 8 | 8 | 1 |
| 527 | 7 | 8 | 1 |
| 528 | 6 | 8 | 1 |
| 529 | 5 | 8 | 1 |
| 530 | 4 | 8 | 1 |
| 531 | 3 | 8 | 1 |
| 532 | 2 | 8 | 1 |
| 533 | 1 | 8 | 1 |
| 534 | 8 | 7 | 8 |
| 535 | 8 | 6 | 8 |
| 536 | 8 | 5 | 8 |
| 537 | 8 | 4 | 8 |
| 538 | 8 | 3 | 8 |
| 539 | 8 | 2 | 8 |
| 540 | 8 | 1 | 8 |
| 541 | 7 | 8 | 8 |
| 542 | 7 | 7 | 8 |
| 543 | 7 | 6 | 8 |
| 544 | 7 | 5 | 8 |
| 545 | 7 | 4 | 8 |
| 546 | 7 | 3 | 8 |
| 547 | 7 | 2 | 8 |
| 548 | 7 | 1 | 8 |
| 549 | 6 | 8 | 8 |
| 550 | 6 | 7 | 8 |
| 551 | 6 | 6 | 8 |
| 552 | 6 | 5 | 8 |
| 553 | 6 | 4 | 8 |
| 554 | 6 | 3 | 8 |
| 555 | 6 | 2 | 8 |
| 556 | 6 | 1 | 8 |
| 557 | 5 | 8 | 8 |
| 558 | 5 | 7 | 8 |
| 559 | 5 | 6 | 8 |
| 560 | 5 | 5 | 8 |
| 561 | 5 | 4 | 8 |
| 562 | 5 | 3 | 8 |
| 563 | 5 | 2 | 8 |
| 564 | 5 | 1 | 8 |
| 565 | 4 | 8 | 8 |
| 566 | 4 | 7 | 8 |
| 567 | 4 | 6 | 8 |
| 568 | 4 | 5 | 8 |
| 569 | 4 | 4 | 8 |
| 570 | 4 | 3 | 8 |
| 571 | 4 | 2 | 8 |
| 572 | 4 | 1 | 8 |
| 573 | 3 | 8 | 8 |
| 574 | 3 | 7 | 8 |
| 575 | 3 | 6 | 8 |
| 576 | 3 | 5 | 8 |
| 577 | 3 | 4 | 8 |
| 578 | 3 | 3 | 8 |
| 579 | 3 | 2 | 8 |
| 580 | 3 | 1 | 8 |
| 581 | 2 | 8 | 8 |
| 582 | 2 | 7 | 8 |
| 583 | 2 | 6 | 8 |
| 584 | 2 | 5 | 8 |
| 585 | 2 | 4 | 8 |
| 586 | 2 | 3 | 8 |
| 587 | 2 | 2 | 8 |
| 588 | 2 | 1 | 8 |
| 589 | 1 | 8 | 8 |
| 590 | 1 | 7 | 8 |
| 591 | 1 | 6 | 8 |
| 592 | 1 | 5 | 8 |
| 593 | 1 | 4 | 8 |
| 594 | 1 | 3 | 8 |
| 595 | 1 | 2 | 8 |
| 596 | 1 | 1 | 8 |
| 597 | 9 | 9 | 8 |
| 598 | 9 | 9 | 7 |
| 599 | 9 | 9 | 6 |
| 600 | 9 | 9 | 5 |
| 601 | 9 | 9 | 4 |
| 602 | 9 | 9 | 3 |
| 603 | 9 | 9 | 2 |
| 604 | 9 | 9 | 1 |
| 605 | 9 | 8 | 9 |
| 606 | 9 | 8 | 8 |
| 607 | 9 | 8 | 7 |
| 608 | 9 | 8 | 6 |
| 609 | 9 | 8 | 5 |
| 610 | 9 | 8 | 4 |
| 611 | 9 | 8 | 3 |
| 612 | 9 | 8 | 2 |
| 613 | 9 | 8 | 1 |
| 614 | 9 | 7 | 9 |
| 615 | 9 | 7 | 8 |
| 616 | 9 | 7 | 7 |
| 617 | 9 | 7 | 6 |
| 618 | 9 | 7 | 5 |
| 619 | 9 | 7 | 4 |
| 620 | 9 | 7 | 3 |
| 621 | 9 | 7 | 2 |
| 622 | 9 | 7 | 1 |
| 623 | 9 | 6 | 9 |
| 624 | 9 | 6 | 8 |
| 625 | 9 | 6 | 7 |
| 626 | 9 | 6 | 6 |
| 627 | 9 | 6 | 5 |
| 628 | 9 | 6 | 4 |
| 629 | 9 | 6 | 3 |
| 630 | 9 | 6 | 2 |
| 631 | 9 | 6 | 1 |
| 632 | 9 | 5 | 9 |
| 633 | 9 | 5 | 8 |
| 634 | 9 | 5 | 7 |
| 635 | 9 | 5 | 6 |
| 636 | 9 | 5 | 5 |
| 637 | 9 | 5 | 4 |
| 638 | 9 | 5 | 3 |
| 639 | 9 | 5 | 2 |
| 640 | 9 | 5 | 1 |
| 641 | 9 | 4 | 9 |
| 642 | 9 | 4 | 8 |
| 643 | 9 | 4 | 7 |
| 644 | 9 | 4 | 6 |
| 645 | 9 | 4 | 5 |
| 646 | 9 | 4 | 4 |
| 647 | 9 | 4 | 3 |
| 648 | 9 | 4 | 2 |
| 649 | 9 | 4 | 1 |
| 650 | 9 | 3 | 9 |
| 651 | 9 | 3 | 8 |
| 652 | 9 | 3 | 7 |
| 653 | 9 | 3 | 6 |
| 654 | 9 | 3 | 5 |
| 655 | 9 | 3 | 4 |
| 656 | 9 | 3 | 3 |
| 657 | 9 | 3 | 2 |
| 658 | 9 | 3 | 1 |
| 659 | 9 | 2 | 9 |
| 660 | 9 | 2 | 8 |
| 661 | 9 | 2 | 7 |
| 662 | 9 | 2 | 6 |
| 663 | 9 | 2 | 5 |
| 664 | 9 | 2 | 4 |
| 665 | 9 | 2 | 3 |
| 666 | 9 | 2 | 2 |
| 667 | 9 | 2 | 1 |
| 668 | 9 | 1 | 9 |
| 669 | 9 | 1 | 8 |
| 670 | 9 | 1 | 7 |
| 671 | 9 | 1 | 6 |
| 672 | 9 | 1 | 5 |
| 673 | 9 | 1 | 4 |
| 674 | 9 | 1 | 3 |
| 675 | 9 | 1 | 2 |
| 676 | 9 | 1 | 1 |
| 677 | 8 | 9 | 9 |
| 678 | 7 | 9 | 9 |
| 679 | 6 | 9 | 9 |
| 680 | 5 | 9 | 9 |
| 681 | 4 | 9 | 9 |
| 682 | 3 | 9 | 9 |
| 683 | 2 | 9 | 9 |
| 684 | 1 | 9 | 9 |
| 685 | 9 | 9 | 8 |
| 686 | 8 | 9 | 8 |
| 687 | 7 | 9 | 8 |
| 688 | 6 | 9 | 8 |
| 689 | 5 | 9 | 8 |
| 690 | 4 | 9 | 8 |
| 691 | 3 | 9 | 8 |
| 692 | 2 | 9 | 8 |
| 693 | 1 | 9 | 8 |
| 694 | 9 | 9 | 7 |
| 695 | 8 | 9 | 7 |
| 696 | 7 | 9 | 7 |
| 697 | 6 | 9 | 7 |
| 698 | 5 | 9 | 7 |
| 699 | 4 | 9 | 7 |
| 700 | 3 | 9 | 7 |
| 701 | 2 | 9 | 7 |
| 702 | 1 | 9 | 7 |
| 703 | 9 | 9 | 6 |
| 704 | 8 | 9 | 6 |
| 705 | 7 | 9 | 6 |
| 706 | 6 | 9 | 6 |
| 707 | 5 | 9 | 6 |
| 708 | 4 | 9 | 6 |
| 709 | 3 | 9 | 6 |
| 710 | 2 | 9 | 6 |
| 711 | 1 | 9 | 6 |
| 712 | 9 | 9 | 5 |
| 713 | 8 | 9 | 5 |
| 714 | 7 | 9 | 5 |
| 715 | 6 | 9 | 5 |
| 716 | 5 | 9 | 5 |
| 717 | 4 | 9 | 5 |
| 718 | 3 | 9 | 5 |
| 719 | 2 | 9 | 5 |
| 720 | 1 | 9 | 5 |
| 721 | 9 | 9 | 4 |
| 722 | 8 | 9 | 4 |
| 723 | 7 | 9 | 4 |
| 724 | 6 | 9 | 4 |
| 725 | 5 | 9 | 4 |
| 726 | 4 | 9 | 4 |
| 727 | 3 | 9 | 4 |
| 728 | 2 | 9 | 4 |
| 729 | 1 | 9 | 4 |
| 730 | 9 | 9 | 3 |
| 731 | 8 | 9 | 3 |
| 732 | 7 | 9 | 3 |
| 733 | 6 | 9 | 3 |
| 734 | 5 | 9 | 3 |
| 735 | 4 | 9 | 3 |
| 736 | 3 | 9 | 3 |
| 737 | 2 | 9 | 3 |
| 738 | 1 | 9 | 3 |
| 739 | 9 | 9 | 2 |
| 740 | 8 | 9 | 2 |
| 741 | 7 | 9 | 2 |
| 742 | 6 | 9 | 2 |
| 743 | 5 | 9 | 2 |
| 744 | 4 | 9 | 2 |
| 745 | 3 | 9 | 2 |
| 746 | 2 | 9 | 2 |
| 747 | 1 | 9 | 2 |
| 748 | 9 | 9 | 1 |
| 749 | 8 | 9 | 1 |
| 750 | 7 | 9 | 1 |
| 751 | 6 | 9 | 1 |
| 752 | 5 | 9 | 1 |
| 753 | 4 | 9 | 1 |
| 754 | 3 | 9 | 1 |
| 755 | 2 | 9 | 1 |
| 756 | 1 | 9 | 1 |
| 757 | 9 | 8 | 9 |
| 758 | 9 | 7 | 9 |
| 759 | 9 | 6 | 9 |
| 760 | 9 | 5 | 9 |
| 761 | 9 | 4 | 9 |
| 762 | 9 | 3 | 9 |
| 763 | 9 | 2 | 9 |
| 764 | 9 | 1 | 9 |
| 765 | 8 | 9 | 9 |
| 766 | 8 | 8 | 9 |
| 767 | 8 | 7 | 9 |
| 768 | 8 | 6 | 9 |
| 769 | 8 | 5 | 9 |
| 770 | 8 | 4 | 9 |
| 771 | 8 | 3 | 9 |
| 772 | 8 | 2 | 9 |
| 773 | 8 | 1 | 9 |
| 774 | 7 | 9 | 9 |
| 775 | 7 | 8 | 9 |
| 776 | 7 | 7 | 9 |
| 777 | 7 | 6 | 9 |
| 778 | 7 | 5 | 9 |
| 779 | 7 | 4 | 9 |
| 780 | 7 | 3 | 9 |
| 781 | 7 | 2 | 9 |
| 782 | 7 | 1 | 9 |
| 783 | 6 | 9 | 9 |
| 784 | 6 | 8 | 9 |
| 785 | 6 | 7 | 9 |
| 786 | 6 | 6 | 9 |
| 787 | 6 | 5 | 9 |
| 788 | 6 | 4 | 9 |
| 789 | 6 | 3 | 9 |
| 790 | 6 | 2 | 9 |
| 791 | 6 | 1 | 9 |
| 792 | 5 | 9 | 9 |
| 793 | 5 | 8 | 9 |
| 794 | 5 | 7 | 9 |
| 795 | 5 | 6 | 9 |
| 796 | 5 | 5 | 9 |
| 797 | 5 | 4 | 9 |
| 798 | 5 | 3 | 9 |
| 799 | 5 | 2 | 9 |
| 800 | 5 | 1 | 9 |
| 801 | 4 | 9 | 9 |
| 802 | 4 | 8 | 9 |
| 803 | 4 | 7 | 9 |
| 804 | 4 | 6 | 9 |
| 805 | 4 | 5 | 9 |
| 806 | 4 | 4 | 9 |
| 807 | 4 | 3 | 9 |
| 808 | 4 | 2 | 9 |
| 809 | 4 | 1 | 9 |
| 810 | 3 | 9 | 9 |
| 811 | 3 | 8 | 9 |
| 812 | 3 | 7 | 9 |
| 813 | 3 | 6 | 9 |
| 814 | 3 | 5 | 9 |
| 815 | 3 | 4 | 9 |
| 816 | 3 | 3 | 9 |
| 817 | 3 | 2 | 9 |
| 818 | 3 | 1 | 9 |
| 819 | 2 | 9 | 9 |
| 820 | 2 | 8 | 9 |
| 821 | 2 | 7 | 9 |
| 822 | 2 | 6 | 9 |
| 823 | 2 | 5 | 9 |
| 824 | 2 | 4 | 9 |
| 825 | 2 | 3 | 9 |
| 826 | 2 | 2 | 9 |
| 827 | 2 | 1 | 9 |
| 828 | 1 | 9 | 9 |
| 829 | 1 | 8 | 9 |
| 830 | 1 | 7 | 9 |
| 831 | 1 | 6 | 9 |
| 832 | 1 | 5 | 9 |
| 833 | 1 | 4 | 9 |
| 834 | 1 | 3 | 9 |
| 835 | 1 | 2 | 9 |
| 836 | 1 | 1 | 9 |
| 837 | 10 | 10 | 9 |
| 838 | 10 | 10 | 8 |
| 839 | 10 | 10 | 7 |
| 840 | 10 | 10 | 6 |
| 841 | 10 | 10 | 5 |
| 842 | 10 | 10 | 4 |
| 843 | 10 | 10 | 3 |
| 844 | 10 | 10 | 2 |
| 845 | 10 | 10 | 1 |
| 846 | 10 | 9 | 10 |
| 847 | 10 | 9 | 9 |
| 848 | 10 | 9 | 8 |
| 849 | 10 | 9 | 7 |
| 850 | 10 | 9 | 6 |
| 851 | 10 | 9 | 5 |
| 852 | 10 | 9 | 4 |
| 853 | 10 | 9 | 3 |
| 854 | 10 | 9 | 2 |
| 855 | 10 | 9 | 1 |
| 856 | 10 | 8 | 10 |
| 857 | 10 | 8 | 9 |
| 858 | 10 | 8 | 8 |
| 859 | 10 | 8 | 7 |
| 860 | 10 | 8 | 6 |
| 861 | 10 | 8 | 5 |
| 862 | 10 | 8 | 4 |
| 863 | 10 | 8 | 3 |
| 864 | 10 | 8 | 2 |
| 865 | 10 | 8 | 1 |
| 866 | 10 | 7 | 10 |
| 867 | 10 | 7 | 9 |
| 868 | 10 | 7 | 8 |
| 869 | 10 | 7 | 7 |
| 870 | 10 | 7 | 6 |
| 871 | 10 | 7 | 5 |
| 872 | 10 | 7 | 4 |
| 873 | 10 | 7 | 3 |
| 874 | 10 | 7 | 2 |
| 875 | 10 | 7 | 1 |
| 876 | 10 | 6 | 10 |
| 878 | 10 | 6 | 9 |
| 879 | 10 | 6 | 8 |
| 880 | 10 | 6 | 7 |
| 881 | 10 | 6 | 6 |
| 882 | 10 | 6 | 5 |
| 883 | 10 | 6 | 4 |
| 884 | 10 | 6 | 3 |
| 885 | 10 | 6 | 2 |
| 886 | 10 | 6 | 1 |
| 887 | 10 | 5 | 10 |
| 888 | 10 | 5 | 9 |
| 889 | 10 | 5 | 8 |
| 890 | 10 | 5 | 7 |
| 891 | 10 | 5 | 6 |
| 892 | 10 | 5 | 5 |
| 893 | 10 | 5 | 4 |
| 894 | 10 | 5 | 3 |
| 895 | 10 | 5 | 2 |
| 896 | 10 | 5 | 1 |
| 897 | 10 | 4 | 10 |
| 898 | 10 | 4 | 9 |
| 899 | 10 | 4 | 8 |
| 900 | 10 | 4 | 7 |
| 901 | 10 | 4 | 6 |
| 902 | 10 | 4 | 5 |
| 903 | 10 | 4 | 4 |
| 904 | 10 | 4 | 3 |
| 905 | 10 | 4 | 2 |
| 906 | 10 | 4 | 1 |
| 907 | 10 | 3 | 10 |
| 908 | 10 | 3 | 9 |
| 909 | 10 | 3 | 8 |
| 910 | 10 | 3 | 7 |
| 911 | 10 | 3 | 6 |
| 912 | 10 | 3 | 5 |
| 913 | 10 | 3 | 4 |
| 914 | 10 | 3 | 3 |
| 915 | 10 | 3 | 2 |
| 916 | 10 | 3 | 1 |
| 917 | 10 | 2 | 10 |
| 918 | 10 | 2 | 9 |
| 919 | 10 | 2 | 8 |
| 920 | 10 | 2 | 7 |
| 921 | 10 | 2 | 6 |
| 922 | 10 | 2 | 5 |
| 923 | 10 | 2 | 4 |
| 924 | 10 | 2 | 3 |
| 925 | 10 | 2 | 2 |
| 926 | 10 | 2 | 1 |
| 927 | 10 | 1 | 10 |
| 928 | 10 | 1 | 9 |
| 929 | 10 | 1 | 8 |
| 930 | 10 | 1 | 7 |
| 931 | 10 | 1 | 6 |
| 932 | 10 | 1 | 5 |
| 933 | 10 | 1 | 4 |
| 934 | 10 | 1 | 3 |
| 935 | 10 | 1 | 2 |
| 936 | 10 | 1 | 1 |
| 937 | 9 | 10 | 10 |
| 938 | 8 | 10 | 10 |
| 939 | 7 | 10 | 10 |
| 940 | 6 | 10 | 10 |
| 941 | 5 | 10 | 10 |
| 942 | 4 | 10 | 10 |
| 943 | 3 | 10 | 10 |
| 944 | 2 | 10 | 10 |
| 945 | 1 | 10 | 10 |
| 946 | 10 | 10 | 9 |
| 947 | 9 | 10 | 9 |
| 948 | 8 | 10 | 9 |
| 950 | 7 | 10 | 9 |
| 951 | 6 | 10 | 9 |
| 952 | 5 | 10 | 9 |
| 953 | 4 | 10 | 9 |
| 954 | 3 | 10 | 9 |
| 955 | 2 | 10 | 9 |
| 956 | 1 | 10 | 9 |
| 957 | 10 | 10 | 8 |
| 958 | 9 | 10 | 8 |
| 959 | 8 | 10 | 8 |
| 960 | 7 | 10 | 8 |
| 961 | 6 | 10 | 8 |
| 962 | 5 | 10 | 8 |
| 963 | 4 | 10 | 8 |
| 964 | 3 | 10 | 8 |
| 965 | 2 | 10 | 8 |
| 966 | 1 | 10 | 8 |
| 967 | 10 | 10 | 7 |
| 968 | 9 | 10 | 7 |
| 969 | 8 | 10 | 7 |
| 970 | 7 | 10 | 7 |
| 971 | 6 | 10 | 7 |
| 972 | 5 | 10 | 7 |
| 973 | 4 | 10 | 7 |
| 974 | 3 | 10 | 7 |
| 975 | 2 | 10 | 7 |
| 976 | 1 | 10 | 7 |
| 977 | 10 | 10 | 6 |
| 978 | 9 | 10 | 6 |
| 979 | 8 | 10 | 6 |
| 980 | 7 | 10 | 6 |
| 981 | 6 | 10 | 6 |
| 982 | 5 | 10 | 6 |
| 983 | 4 | 10 | 6 |
| 984 | 3 | 10 | 6 |
| 985 | 2 | 10 | 6 |
| 986 | 1 | 10 | 6 |
| 987 | 10 | 10 | 5 |
| 988 | 9 | 10 | 5 |
| 989 | 8 | 10 | 5 |
| 990 | 7 | 10 | 5 |
| 991 | 6 | 10 | 5 |
| 992 | 5 | 10 | 5 |
| 993 | 4 | 10 | 5 |
| 994 | 3 | 10 | 5 |
| 995 | 2 | 10 | 5 |
| 996 | 1 | 10 | 5 |
| 997 | 10 | 10 | 4 |
| 998 | 9 | 10 | 4 |
| 999 | 8 | 10 | 4 |
| 1000 | 7 | 10 | 4 |
| 1001 | 6 | 10 | 4 |
| 1002 | 5 | 10 | 4 |
| 1003 | 4 | 10 | 4 |
| 1004 | 3 | 10 | 4 |
| 1005 | 2 | 10 | 4 |
| 1006 | 1 | 10 | 4 |
| 1007 | 10 | 10 | 3 |
| 1008 | 9 | 10 | 3 |
| 1009 | 8 | 10 | 3 |
| 1010 | 7 | 10 | 3 |
| 1011 | 6 | 10 | 3 |
| 1012 | 5 | 10 | 3 |
| 1013 | 4 | 10 | 3 |
| 1014 | 3 | 10 | 3 |
| 1015 | 2 | 10 | 3 |
| 1016 | 1 | 10 | 3 |
| 1017 | 10 | 10 | 2 |
| 1018 | 9 | 10 | 2 |
| 1019 | 8 | 10 | 2 |
| 1020 | 7 | 10 | 2 |
| 1021 | 6 | 10 | 2 |
| 1022 | 5 | 10 | 2 |
| 1023 | 4 | 10 | 2 |
| 1024 | 3 | 10 | 2 |
| 1025 | 2 | 10 | 2 |
| 1026 | 1 | 10 | 2 |
| 1027 | 10 | 10 | 1 |
| 1028 | 9 | 10 | 1 |
| 1029 | 8 | 10 | 1 |
| 1030 | 7 | 10 | 1 |
| 1031 | 6 | 10 | 1 |
| 1032 | 5 | 10 | 1 |
| 1033 | 4 | 10 | 1 |
| 1034 | 3 | 10 | 1 |
| 1035 | 2 | 10 | 1 |
| 1036 | 1 | 10 | 1 |
| 1037 | 10 | 9 | 10 |
| 1038 | 10 | 8 | 10 |
| 1039 | 10 | 7 | 10 |
| 1040 | 10 | 6 | 10 |
| 1041 | 10 | 5 | 10 |
| 1042 | 10 | 4 | 10 |
| 1043 | 10 | 3 | 10 |
| 1044 | 10 | 2 | 10 |
| 1045 | 10 | 1 | 10 |
| 1046 | 9 | 10 | 10 |
| 1047 | 9 | 9 | 10 |
| 1048 | 9 | 8 | 10 |
| 1049 | 9 | 7 | 10 |
| 1050 | 9 | 6 | 10 |
| 1051 | 9 | 5 | 10 |
| 1052 | 9 | 4 | 10 |
| 1053 | 9 | 3 | 10 |
| 1054 | 9 | 2 | 10 |
| 1055 | 9 | 1 | 10 |
| 1056 | 8 | 10 | 10 |
| 1057 | 8 | 9 | 10 |
| 1058 | 8 | 8 | 10 |
| 1059 | 8 | 7 | 10 |
| 1060 | 8 | 6 | 10 |
| 1061 | 8 | 5 | 10 |
| 1062 | 8 | 4 | 10 |
| 1063 | 8 | 3 | 10 |
| 1064 | 8 | 2 | 10 |
| 1065 | 8 | 1 | 10 |
| 1066 | 7 | 10 | 10 |
| 1067 | 7 | 9 | 10 |
| 1068 | 7 | 8 | 10 |
| 1069 | 7 | 7 | 10 |
| 1070 | 7 | 6 | 10 |
| 1071 | 7 | 5 | 10 |
| 1072 | 7 | 4 | 10 |
| 1073 | 7 | 3 | 10 |
| 1074 | 7 | 2 | 10 |
| 1075 | 7 | 1 | 10 |
| 1076 | 6 | 10 | 10 |
| 1077 | 6 | 9 | 10 |
| 1078 | 6 | 8 | 10 |
| 1079 | 6 | 7 | 10 |
| 1080 | 6 | 6 | 10 |
| 1081 | 6 | 5 | 10 |
| 1082 | 6 | 4 | 10 |
| 1083 | 6 | 3 | 10 |
| 1084 | 6 | 2 | 10 |
| 1085 | 6 | 1 | 10 |
| 1086 | 5 | 10 | 10 |
| 1087 | 5 | 9 | 10 |
| 1088 | 5 | 8 | 10 |
| 1089 | 5 | 7 | 10 |
| 1090 | 5 | 6 | 10 |
| 1091 | 5 | 5 | 10 |
| 1092 | 5 | 4 | 10 |
| 1093 | 5 | 3 | 10 |
| 1094 | 5 | 2 | 10 |
| 1095 | 5 | 1 | 10 |
| 1096 | 4 | 10 | 10 |
| 1097 | 4 | 9 | 10 |
| 1098 | 4 | 8 | 10 |
| 1099 | 4 | 7 | 10 |
| 1200 | 4 | 6 | 10 |
| 1201 | 4 | 5 | 10 |
| 1202 | 4 | 4 | 10 |
| 1203 | 4 | 3 | 10 |
| 1204 | 4 | 2 | 10 |
| 1205 | 4 | 1 | 10 |
| 1206 | 3 | 10 | 10 |
| 1207 | 3 | 9 | 10 |
| 1208 | 3 | 8 | 10 |
| 1209 | 3 | 7 | 10 |
| 1210 | 3 | 6 | 10 |
| 1211 | 3 | 5 | 10 |
| 1212 | 3 | 4 | 10 |
| 1213 | 3 | 3 | 10 |
| 1214 | 3 | 2 | 10 |
| 1215 | 3 | 1 | 10 |
| 1216 | 2 | 10 | 10 |
| 1217 | 2 | 9 | 10 |
| 1218 | 2 | 8 | 10 |
| 1219 | 2 | 7 | 10 |
| 1220 | 2 | 6 | 10 |
| 1221 | 2 | 5 | 10 |
| 1222 | 2 | 4 | 10 |
| 1223 | 2 | 3 | 10 |
| 1224 | 2 | 2 | 10 |
| 1225 | 2 | 1 | 10 |
| 1226 | 1 | 10 | 10 |
| 1227 | 1 | 9 | 10 |
| 1228 | 1 | 8 | 10 |
| 1229 | 1 | 7 | 10 |
| 1230 | 1 | 6 | 10 |
| 1231 | 1 | 5 | 10 |
| 1232 | 1 | 4 | 10 |
| 1233 | 1 | 3 | 10 |
| 1234 | 1 | 2 | 10 |
| 1235 | 1 | 1 | 10 |

### Definitions

Unless otherwise defined, scientific and technical terms used in connection with the disclosure shall have the meanings that are commonly understood by those of ordinary skill in the art. Further, unless otherwise required by context, singular terms shall include pluralities and plural terms shall include the singular. Generally, nomenclatures utilized in connection with, and techniques of, chemistry, physics, small molecules, biochemistry, molecular biology, and protein and oligo- or polynucleotide chemistry described herein are those well-known and commonly used in the art.

The following definitions are useful in understanding the present invention:

Adhesive components of the disclosure may be isolated, derived, or prepared from any species, including any virus.

Adhesive components of the disclosure may be isolated, derived, or prepared from any species, including any prokaryotic cell.

Adhesive components of the disclosure may be isolated, derived, or prepared from any species, including any eukaryotic cell.

Adhesive components of the disclosure may be isolated, derived, or prepared from any species, including any plant.

Adhesive components of the disclosure may be isolated, derived, or prepared from any species, including any animal, any vertebrate, any invertebrate, reptile, fish, amphibian, marsupial, bird or mammal.

A “mammal” for purposes of treating n infection, refers to any mammal, including humans, domestic and farm animals, and zoo, sports, or pet animals, such as dogs, cats, cattle, horses, sheep, pigs, goats, rabbits, etc. Preferably, the mammal is human.

A “small molecule” is defined herein to have a molecular weight below about 500 Daltons.

The terms “nucleic acid” and “polynucleotide” are used interchangeably herein to refer to single- or double-stranded RNA, DNA, or mixed polymers. Polynucleotides of the disclosure may include sequences specifically selected for their lack of homology or identity of any known sequence in any plant, animal or viral genome, and, accordingly, may be used entirely as a material for adhesion that is not expected to interact with any endogenous or native polynucleotide in vivo or ex vivo.

An “isolated nucleic acid” is a nucleic acid that is substantially separated from other genome DNA sequences as well as proteins or complexes such as ribosomes and polymerases, which naturally accompany a native sequence. The term embraces a nucleic acid sequence that has been removed from its naturally occurring environment, and includes recombinant or cloned DNA isolates and chemically synthesized analogues or analogues biologically synthesized by heterologous systems.

The term “polypeptide” is used in its conventional meaning, i.e., as a sequence of amino acids. The polypeptides are not limited to a specific length of the product. Peptides, oligopeptides, and proteins are included within the definition of polypeptide, and such terms may be used interchangeably herein unless specifically indicated otherwise. This term also does not refer to or exclude post-expression modifications of the polypeptide, for example, glycosylations, acetylations, phosphorylations and the like, as well as other modifications known in the art, both naturally occurring and non-naturally occurring. A polypeptide may be an entire protein, or a subsequence thereof.

An “isolated polypeptide” is one that has been identified and separated and/or recovered from its natural environment.

A “native sequence” polypeptide is one that has the same amino acid sequence as a polypeptide found in nature (e.g., from any species). Such native sequence polynucleotides and polypeptides can be isolated from nature or can be produced by recombinant or synthetic means.

A polynucleotide “variant,” as the term is used herein, is a polynucleotide that typically differs from a polynucleotide specifically disclosed herein in one or more substitutions, deletions, additions and/or insertions. Such variants may be naturally occurring or may be synthetically generated, for example, by modifying one or more of the polynucleotide sequences of the invention and evaluating one or more biological activities of the encoded polypeptide as described herein and/or using any of a number of techniques well known in the art.

A polypeptide “variant,” as the term is used herein, is a polypeptide that typically differs from a polypeptide specifically disclosed herein in one or more substitutions, deletions, additions and/or insertions. Such variants may be naturally occurring or may be synthetically generated, for example, by modifying one or more of the above polypeptide sequences of the invention and evaluating one or more biological activities of the polypeptide as described herein and/or using any of a number of techniques well known in the art.

Modifications may be made in the structure of the polynucleotides and polypeptides of the disclosure and still obtain a functional molecule that encodes a variant or derivative polypeptide with desirable characteristics. When it is desired to alter the amino acid sequence of a polypeptide to create an equivalent, or even an improved, variant or portion of a polypeptide of the invention, one skilled in the art will typically change one or more of the codons of the encoding DNA sequence.

For example, certain amino acids may be substituted for other amino acids in a protein structure without appreciable loss of its ability to bind other polypeptides (e.g., antigens) or cells. Because it is the binding capacity and nature of a protein that defines that protein's biological functional activity, certain amino acid sequence substitutions can be made in a protein sequence, and, of course, its underlying DNA coding sequence, and nevertheless obtain a protein with like properties. It is thus contemplated that various changes may be made in the peptide sequences of the disclosed compositions, or corresponding DNA sequences that encode said peptides without appreciable loss of their biological utility or activity.

In many instances, a polypeptide variant will contain one or more conservative substitutions. A “conservative substitution” is one in which an amino acid is substituted for another amino acid that has similar properties, such that one skilled in the art of peptide chemistry would expect the secondary structure and hydropathic nature of the polypeptide to be substantially unchanged.

In making such changes, the hydropathic index of amino acids may be considered. The importance of the hydropathic amino acid index in conferring interactive biologic function on a protein is generally understood in the art (Kyte and Doolittle, 1982). It is accepted that the relative hydropathic character of the amino acid contributes to the secondary structure of the resultant protein, which in turn defines the interaction of the protein with other molecules, for example, enzymes, substrates, receptors, DNA, antibodies, antigens, and the like. Each amino acid has been assigned a hydropathic index on the basis of its hydrophobicity and charge characteristics (Kyte and Doolittle, 1982). These values are: isoleucine (+4.5); valine (+4.2); leucine (+3.8); phenylalanine (+2.8); cysteine/cystine (+2.5); methionine (+1.9); alanine (+1.8); glycine (−0.4); threonine (−0.7); serine (−0.8); tryptophan (−0.9); tyrosine (−1.3); proline (−1.6); histidine (−3.2); glutamate (−3.5); glutamine (−3.5); aspartate (−3.5); asparagine (−3.5); lysine (−3.9); and arginine (−4.5).

Certain amino acids may be substituted by other amino acids having a similar hydropathic index or score and still result in a protein with similar biological activity, i.e. still obtain a biological functionally equivalent protein. In making such changes, the substitution of amino acids whose hydropathic indices are within ±2 is preferred, those within ±1 are particularly preferred, and those within ±0.5 are even more particularly preferred. The substitution of like amino acids can be made effectively on the basis of hydrophilicity. The greatest local average hydrophilicity of a protein, as governed by the hydrophilicity of its adjacent amino acids, correlates with a biological property of the protein.

The following hydrophilicity values have been assigned to amino acid residues: arginine (+3.0); lysine (+3.0); aspartate (+3.0±1); glutamate (+3.0±1); serine (+0.3); asparagine (+0.2); glutamine (+0.2); glycine (0); threonine (−0.4); proline (−0.5±1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); tryptophan (−3.4). It is understood that an amino acid can be substituted for another having a similar hydrophilicity value and still obtain a biologically equivalent, and in particular, an immunologically equivalent protein. In such changes, the substitution of amino acids whose hydrophilicity values are within ±2 is preferred, those within ±1 are particularly preferred, and those within ±0.5 are even more particularly preferred.

As outlined above, amino acid substitutions are generally therefore based on the relative similarity of the amino acid side-chain substituents, for example, their hydrophobicity, hydrophilicity, charge, size, and the like. Exemplary substitutions that take various of the foregoing characteristics into consideration are well known to those of skill in the art and include: arginine and lysine; glutamate and aspartate; serine and threonine; glutamine and asparagine; and valine, leucine and isoleucine.

Amino acid substitutions may further be made on the basis of similarity in polarity, charge, solubility, hydrophobicity, hydrophilicity and/or the amphipathic nature of the residues. For example, negatively charged amino acids include aspartic acid and glutamic acid; positively charged amino acids include lysine and arginine; and amino acids with uncharged polar head groups having similar hydrophilicity values include leucine, isoleucine and valine; glycine and alanine; asparagine and glutamine; and serine, threonine, phenylalanine and tyrosine. Other groups of amino acids that may represent conservative changes include: (1) ala, pro, gly, glu, asp, gln, asn, ser, thr; (2) cys, ser, tyr, thr; (3) val, ile, leu, met, ala, phe; (4) lys, arg, his; and (5) phe, tyr, trp, his. A variant may also, or alternatively, contain nonconservative changes. In a preferred embodiment, variant polypeptides differ from a native sequence by substitution, deletion or addition of five amino acids or fewer. Variants may also (or alternatively) be modified by, for example, the deletion or addition of amino acids that have minimal influence on the immunogenicity, secondary structure and hydropathic nature of the polypeptide.

When comparing polynucleotide and/or polypeptide sequences, two sequences are said to be “identical” if the sequence of nucleotides or amino acids in the two sequences is the same when aligned for maximum correspondence, as described below. Comparisons between two sequences are typically performed by comparing the sequences over a comparison window to identify and compare local regions of sequence similarity. A “comparison window” as used herein, refers to a segment of at least about 20 contiguous positions, usually 30 to about 75, 40 to about 50, in which a sequence may be compared to a reference sequence of the same number of contiguous positions after the two sequences are optimally aligned.

“Homology” refers to the percentage of residues in the polynucleotide or polypeptide sequence variant that are identical to the non-variant sequence after aligning the sequences and introducing gaps, if necessary, to achieve the maximum percent homology. In particular embodiments, polynucleotide and polypeptide variants have at least 70%, at least 75%, at least 80%, at least 90%, at least 95%, at least 98%, or at least 99% polynucleotide or polypeptide homology with a polynucleotide or polypeptide described herein.

As used in this specification and the appended claims, the singular forms “a,” “an” and “the” include plural references unless the content clearly dictates otherwise.

### EXAMPLES

### Example 1: Adhesive Compositions

Candidate materials studied for inclusion in the adhesive compositions of the disclosure are shown in Tables 2A and 2B below.

TABLE 2A

| | High MW | | Medium - Low | | | |
|---|---|---|---|---|---|---|
| | Insoluble | | MW Insoluble | | | |
| | | Wt. % | | Wt. % Med- | Glycoprotein Substitute | |
| # | Type | High MW | Type | Low MW | Type | Wt. % |
| 1 | CNF | 46.15 | Casein | 46.15 | Poly(vinyl Alcohol) (Z009-563) | 7.7 |
| 2 | | 46.15 | | 46.15 | Starch, soluble (Z004-809) | 7.7 |
| 3 | | 46.15 | | 46.15 | Soy Hydrosylate Enzymatic (Z013-933) | 7.7 |
| 4 | | 46.15 | Chitosin | 46.15 | Poly(vinyl Alcohol) (Z009-563) | 7.7 |
| 5 | | 46.15 | (SA) | 46.15 | Starch, soluble (Z004-809) | 7.7 |
| 6 | | 46.15 | | 46.15 | Soy Hydrosylate Enzymatic (Z013-933) | 7.7 |
| 7 | Wood | 46.15 | Casein | 46.15 | Poly(vinyl Alcohol) (Z009-563) | 7.7 |
| 8 | Flour | 46.15 | | 46.15 | Starch, soluble (Z004-809) | 7.7 |
| 9 | | 46.15 | | 46.15 | Soy Hydrosylate Enzymatic (Z013-933) | 7.7 |
| 10 | | 46.15 | Chitosin | 46.15 | Poly(vinyl Alcohol) (Z009-563) | 7.7 |
| 11 | | 46.15 | (SA) | 46.15 | Starch, soluble (Z004-809) | 7.7 |
| 12 | | 46.15 | | 46.15 | Soy Hydrosylate Enzymatic (Z013-933) | 7.7 |
| 13 | Rice | 46.15 | Casein | 46.15 | Poly(vinyl Alcohol) (Z009-563) | 7.7 |
| 14 | Protein | 46.15 | | 46.15 | Starch, soluble (Z004-809) | 7.7 |
| 15 | | 46.15 | | 46.15 | Soy Hydrosylate Enzymatic (Z013-933) | 7.7 |
| 16 | | 46.15 | Chitosin | 46.15 | Poly(vinyl Alcohol) (Z009-563) | 7.7 |
| 17 | | 46.15 | (SA) | 46.15 | Starch, soluble (Z004-809) | 7.7 |
| 18 | | 46.15 | | 46.15 | Soy Hydrosylate Enzymatic (Z013-933) | 7.7 |

TABLE 2B

| | | Molecular Weight Range | | |
|---|---|---|---|---|
| | | High | Medium | Low |
| Material | Water Solubility | (1,000,000-100,000 Daltons) | (35,000-20,000 Daltons) | (20,000-1 Dalton) |
| Soy Protein isolated | Dispersion | X | | |
| NutriBiotics Raw Organic | Dispersion | X | | |
| Plain Rice Protein | | | | |
| Lifestream Algal Pure Protein | Dispersion | X | | |
| Wood Flour | No | X | | |
| Cellulose Nano-Fibers | No | X | | |
| Silk Fibroin (10 & 2 μm) | No | 250,000 | | |
| Chitin | No | X | | |
| Chitosan | No | 300,000-100,000 | | |
| K-Casein | No | | 30,000-28,000 | |
| Sericin | Soluble at 20 Wt. % | | X | |
| Soy Hydrosylate Enzymatic | Soluble at 5-25 Wt. % | | | X |
| Yeast Extract | Soluble at 5-20 Wt. % | | | X |
| Yeast Hydrosylate Enzymatic | Soluble at 5-20 Wt. % | | | X |
| Poly(vinyl alcohol), 87-89% | Soluble at 5 Wt. % | | | 13,000 |
| hydrolyzed | | | | |
| Starch (soluble) | Soluble at 5 Wt. % | | | X |
| Microbial Transglutaminase | Dispersion | | | |

General Formulation Procedure: The appropriate amounts of dry ingredients or pastes were weighed directly into a 10 gram Speedmixer cup. The appropriate amounts of aqueous ingredient solution were weighed directly in the above Speedmixer cup. The Speedmixer cup (generally 6 cups were mixed at a time) was placed into the 6-position Speedmixer sample holder which was then placed and secured into the Speedmixer (FlackTec, Inc., model DAC 400FVZ). Formulations were shear-mixed according to the schedule of Table 3. Formulations were removed from the Speedmixer and used for substrate bonding for lap shear testing within 1 to 3 days.

TABLE 3

| Cycle | 1 | 2 | 3 | 4 | 5 |
|---|---|---|---|---|---|
| Speed (rpm) | 2000 | 2000 | 2000 | 2000 | 1500 |
| Time (min.) | 2 | 2 | 2 | 2 | 2 |

Formulation Compositions and Aqueous Dispersion/Solution Procedures: Poly(vinyl alcohol) was dissolved in water at 5 Wt. % by stirring the appropriate amount into water, heating to 80° C. for 35 minutes, then cooling back down to ambient temperatures. Starch was dissolved in water at 5 Wt. % by stirring the appropriate amount into water, heating to 60° C. until a solution formed, then cooling back down to ambient temperatures. Soy hydrosylate enzymatic was dissolved in ambient temperature water at 5, 20 or 25 Wt. %. Yeast Extract was dissolved in ambient temperature water at 20 Wt. %. Yeast hydrosylate enzymatic was dissolved in ambient temperature water at 20 Wt. %. Sericin was dissolved in ambient temperature water at 20 Wt. %.

Water (1 gram) was added to each formulation in order to make the resulting mixture easier to spread onto the substrate (Tin free steel, Kraft paper, wood veneer). For formulation 252-28A, an aqueous 5 Wt. % poly(vinyl alcohol) solution was used as the formulation. For formulation 252-28B, an aqueous 10 Wt. % soy hydrosylate enzymatic solution was used as the formulation. For formulation 252-30, 4.635 grams water was added to 2.685 grams k-casein in a Speedmixer cup and shear-mixed as previously described.

All initial formulations are described in Tables 4A-4H below.

TABLE 4A
Formulations Tested

| Reagent | Stock % | 252-21A | 252-21B | 252-21C | 252-21D | 252-21E | 252-21F |
|---|---|---|---|---|---|---|---|
| CNF | 12 | 4.936 | 4.936 | 4.936 | 4.936 | 4.936 | 4.936 |
| Chitosan | 100 | 0.592 | 0.592 | 0.592 | 0.000 | 0.000 | 0.000 |
| Casein | 100 | 0.000 | 0.000 | 0.000 | 0.592 | 0.592 | 0.592 |
| PVOH | 5 | 1.974 | 0.000 | 0.000 | 1.974 | 0.000 | 0.000 |
| Starch, soluble | 5 | 0.000 | 1.974 | 0.000 | 0.000 | 1.974 | 0.000 |
| Soy hydrosylate | 5 | 0.000 | 0.000 | 1.974 | 0.000 | 0.000 | 1.974 |
| Mass check | | 7.502 | 7.502 | 7.502 | 7.502 | 7.502 | 7.502 |
| Solution mass | | 7.5 | 7.5 | 7.5 | 7.5 | 7.5 | 7.5 |
| % Solids | | 17.11 | 17.11 | 17.11 | 17.11 | 17.11 | 17.11 |

TABLE 4B
Formulations Tested

| Reagent | Stock % | 252-22A | 252-22B | 252-22C | 252-22D | 252-22E | 252-22F |
|---|---|---|---|---|---|---|---|
| Wood Flour | 100 | 1.406 | 1.406 | 1.406 | 1.406 | 1.406 | 1.406 |
| Chitosan | 100 | 1.406 | 1.406 | 1.406 | 0.000 | 0.000 | 0.000 |
| Casein | 100 | 0.000 | 0.000 | 0.000 | 1.406 | 1.406 | 1.406 |
| PVOH | 5 | 4.686 | 0.000 | 0.000 | 4.686 | 0.000 | 0.000 |
| Starch, soluble | 5 | 0.000 | 4.686 | 0.000 | 0.000 | 4.686 | 0.000 |
| Soy hydrosylate | 5 | 0.000 | 0.000 | 4.686 | 0.000 | 0.000 | 4.686 |
| Mass check | | 7.499 | 7.499 | 7.499 | 7.499 | 7.499 | 7.499 |
| Solution mass | | 7.5 | 7.5 | 7.5 | 7.5 | 7.5 | 7.5 |
| % Solids | | 40.625 | 40.625 | 40.625 | 40.625 | 40.625 | 40.625 |

TABLE 4C
Formulations Tested

| Reagent | Stock % | 252-23A | 252-23B | 252-23C | 252-23D | 252-23E | 252-23F |
|---|---|---|---|---|---|---|---|
| Organic Rice Protein | 100 | 1.406 | 1.406 | 1.406 | 1.406 | 1.406 | 1.406 |
| Chitosan | 100 | 1.406 | 1.406 | 1.406 | 0.000 | 0.000 | 0.000 |
| Casein | 100 | 0.000 | 0.000 | 0.000 | 1.406 | 1.406 | 1.406 |
| PVOH | 5 | 4.686 | 0.000 | 0.000 | 4.686 | 0.000 | 0.000 |
| Starch, soluble | 5 | 0.000 | 4.686 | 0.000 | 0.000 | 4.686 | 0.000 |
| Soy hydrosylate | 5 | 0.000 | 0.000 | 4.686 | 0.000 | 0.000 | 4.686 |
| Mass check | | 7.499 | 7.499 | 7.499 | 7.499 | 7.499 | 7.499 |
| Solution mass | | 7.5 | 7.5 | 7.5 | 7.5 | 7.5 | 7.5 |
| % Solids | | 40.625 | 40.625 | 40.625 | 40.625 | 40.625 | 40.625 |

TABLE 4D
Formulations Tested

| Reagent | Stock % | 252-31A | 252-31B | 252-31C | 252-31D |
|---|---|---|---|---|---|
| Organic Rice Protein | 100 | 1.239 | 1.033 | 0.826 | 0.620 |
| Chitosan | 100 | 0.000 | 0.000 | 0.000 | 0.000 |
| Casein | 100 | 1.239 | 1.033 | 0.826 | 0.620 |
| PVOH | 5 | 0.000 | 0.000 | 0.000 | 0.000 |
| Starch, soluble | 5 | 0.000 | 0.000 | 0.000 | 0.000 |
| Soy hydrosylate | 25 | 0.826 | 2.479 | 4.131 | 5.782 |
| Water | | 4.196 | 2.956 | 1.717 | 0.478 |
| Mass check | | 7.500 | 4.544 | 5.783 | 7.022 |
| Solution mass | | 7.5 | 7.5 | 7.5 | 7.5 |
| % Solids | | 35.8 | 35.8 | 35.8 | 35.8 |

TABLE 4E
Formulations Tested

| Reagent | Stock % | 252-36 |
|---|---|---|
| Organic Rice Protein | 100 | 6.609 |
| Chitosan | 100 | 0.000 |
| Casein | 100 | 6.609 |
| PVOH | 5 | 0.000 |
| Starch, soluble | 5 | 0.000 |
| Soy hydrosylate | 25 | 33.045 |
| Water | | 13.736 |
| Mass check | | 46.264 |
| Solution mass | | 60 |
| % Solids | | 35.8 |

TABLE 4F
Formulations Tested

| Reagent | Stock % | 252-39A | 252-39B | 252-39E | 252-39F |
|---|---|---|---|---|---|
| Organic Rice Protein | 100 | 0.826 | 0.000 | 0.826 | 0.826 |
| Soy Protein, Isolated | 100 | 0.000 | 0.826 | 0.000 | 0.000 |
| Casein | 100 | 0.826 | 0.826 | 0.826 | 0.826 |
| Soy hydrosylate | 25 | 4.131 | 4.131 | 0.000 | 0.000 |
| Yeast Extract | 20 | 0.000 | 0.000 | 5.163 | 0.000 |
| Yeast Extract hydrosylate | 20 | 0.000 | 0.000 | 0.000 | 5.163 |
| Water | | 1.717 | 1.717 | 0.684 | 0.684 |
| Mass check | | 7.500 | 7.500 | 7.500 | 7.500 |
| Solution mass | | 7.5 | 7.5 | 7.5 | 7.5 |
| % Solids | | 35.8 | 35.8 | 35.8 | 35.8 |

TABLE 4G
Formulations Tested

| Reagent | Stock % | 252-42A | 252-42B | 252-42C | 252-42D | 252-42E | 252-42F |
|---|---|---|---|---|---|---|---|
| Organic Rice Protein | 100 | 0.826 | 0.767 | 0.000 | 0.000 | 0.000 | 0.000 |
| Silk Fibroin, 10 um | 100 | 0.000 | 0.000 | 0.826 | 0.000 | 0.826 | 0.000 |
| Casein | 100 | 0.826 | 0.767 | 0.826 | 0.826 | 0.826 | 0.826 |
| Silk Fibroin, 2 um | 100 | 0.000 | 0.000 | 0.000 | 0.826 | 0.000 | 0.826 |
| Sericin | 20 | 0.000 | 0.000 | 0.000 | 0.000 | 5.163 | 5.163 |
| Soy hydrosylate | 20 | 5.163 | 4.794 | 5.163 | 5.163 | 0.000 | 0.000 |
| Microbial | 100 | 0.000 | 0.192 | 0.000 | 0.000 | 0.000 | 0.000 |
| Transglutaminase | | | | | | | |
| Water | | 0.684 | 0.980 | 0.684 | 0.684 | 0.684 | 0.684 |
| Mass check | | 7.500 | 7.500 | 7.500 | 7.500 | 7.500 | 7.500 |
| Solution mass | | 7.5 | 7.5 | 7.5 | 7.5 | 7.5 | 7.5 |
| % Solids | | 35.8 | 35.8 | 35.8 | 35.8 | 35.8 | 35.8 |

TABLE 4H
Formulations Tested

| Reagent | Stock % | 252-43B |
|---|---|---|
| Organic Rice Protein | 100 | 0.826 |
| Silk Fibroin, 10 um | 100 | 0.000 |
| Casein | 100 | 0.826 |
| Silk Fibroin, 2 um | 100 | 0.000 |
| Sericin | 20 | 5.163 |
| Soy hydrosylate | 20 | 0.000 |
| Water | | 0.684 |
| Mass check | | 7.500 |
| Solution mass | | 7.5 |
| % Solids | | 35.8 |

Lap Shear Adhesive Testing: Substrates consisted of either 1 inch wide Tin Free Steel, Kraft Paper, or White Oak (Sauers & Company 2-Ply Wood on Wood Veneer) Veneer strips.

The lap shear test specimen was assembled as follows: Duct tape (Nashua Trusted Tape Products, 48 mm wide, 0.25 mm thick) was applied to one end of the substrate strip such that a 1 inch square bonding area of substrate surface between two strips of duct tape was created. Either 2 (only for formulation 252-22D,E,F) or 4 (remaining formulations) duct tape layers were used to produce a 1 inch square bonding area with either a 0.5 or 1.0 mm thickness, respectively. The formulation to be studied was spread evenly over the bonding area. Another strip of the same substrate was placed on top of the above mentioned strip such that it overlapped the bottom strip and covered both duct tape strips. Pressure was applied over the bonding area such that a uniform formulation layer with the same thickness as the duct tape layers was produced. Excess formulation which squeezed out of the bonding area was removed. Small binder clips (ACCO #72029) were clamped onto the strips over the duct tape layers and used to hold the strips in place until the formulation dried. Lap shear test specimens were allowed to dry for a minimum of 48 hours at ambient temperatures before testing. This initial dry time was reduced to 24 hours after a dry time versus Max Force experiment was performed (to be discussed later). Specimens 252-28A and 28B were dried at 50° C. overnight to assist the drying process. After drying, the small binder clips were removed prior to testing.

Lap Shear Adhesive testing was carried out as follows: The lap shear specimen was initially suspended vertically from one end with a small binder clip attached to the opposite end to assist in holding the specimen vertical. The specimen is allowed to hang vertically for 5 seconds and those specimens that do not come apart continue on in the test procedure. Lap Shear testing was performed using a Shimadzu AG-1C mechanical test machine in tensile mode using a crosshead speed of 1.3 mm/min with test data collection and calculations being performed using Trapezium Version 1.4.0 software. Tin Free Steel specimens 252-21A-F and 252-22D-F utilized a 200 N load cell with pneumatic grips set at a gap length of 270 mm. Tin Free Steel specimens 252-22A-C and 252-23A-F and all specimens using Kraft Paper and Wood Veneer strips utilized a 20 kN load cell with manual wedge grips set at a gap length of 270 mm.

The test specimen was first clamped into the top grip which is attached to the crosshead such that it hangs vertically and rests within the open bottom grip. The bottom grip is then clamped shut such that there is no bending, bowing, or significant tensile force placed on the test specimen. Testing was initiated and the Maximum Force (N) as a function of crosshead displacement is monitored. Testing was continued for a while after the initial bond break was detected to ensure all significant data was collected. The Max Force (N) obtained (all specimens) and Energy to Break (mJ) (some specimens) were measured and the average values along with their standard deviation reported.

On Tin Free Steel:

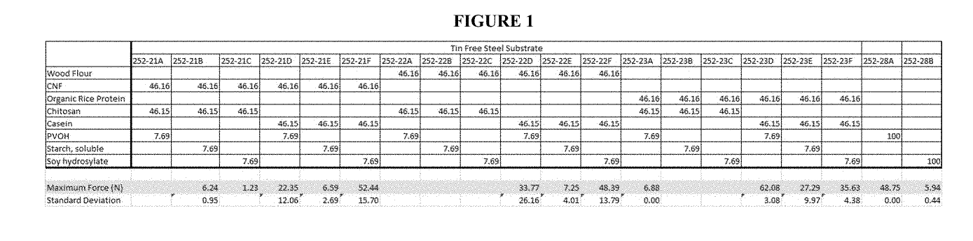

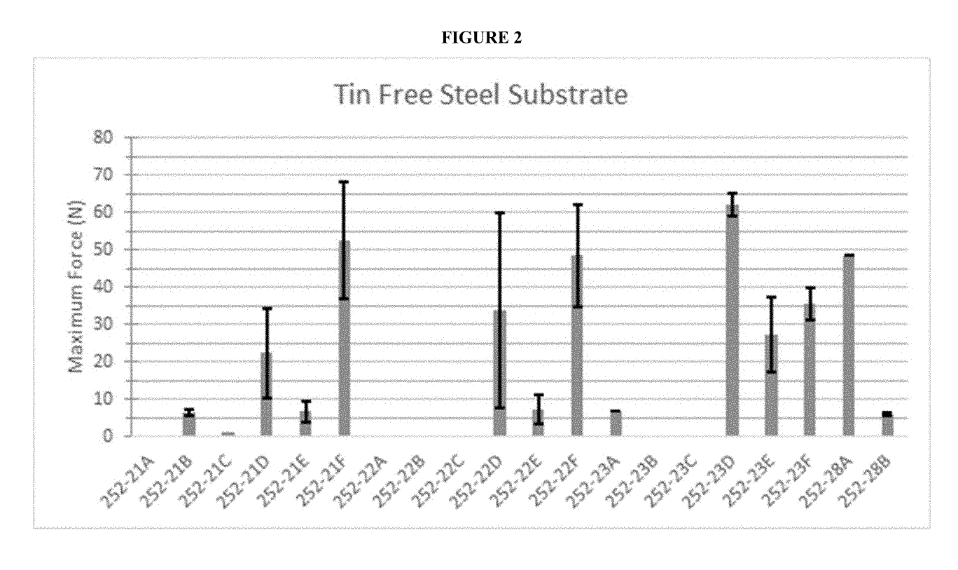

Keeping the other components of the formulations and their content the same with 46.16 Wt. % of either Wood Flour or Cellulose Nano-fibers or Organic Rice Protein, formulations containing Organic Rice Protein appear to exhibit higher Max Force values than formulations containing Wood Flour or Cellulose Nano-fibers (See FIGS. 1 and 2).

On Kraft Paper:

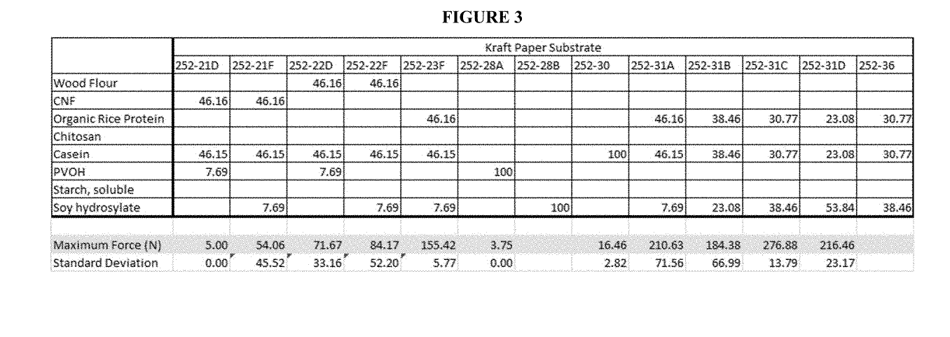

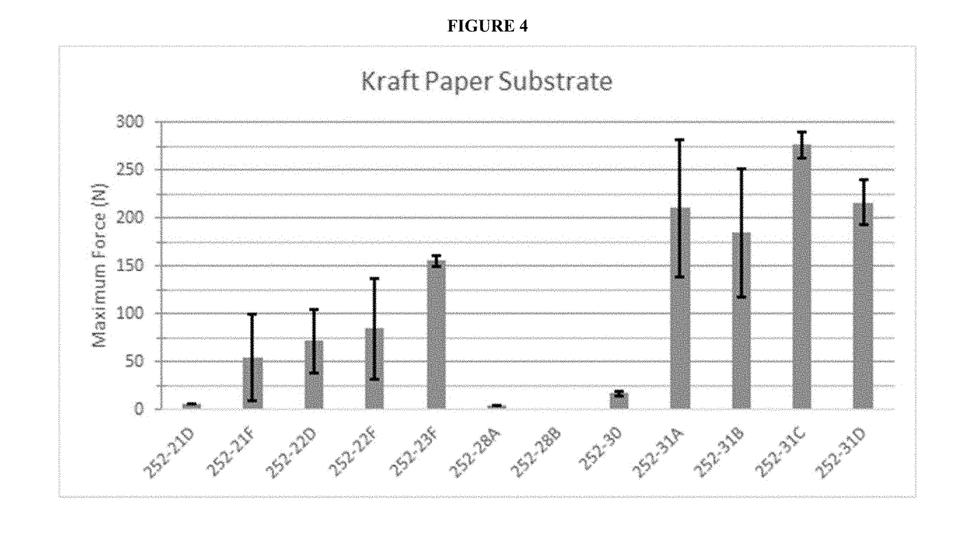

Use of either soy hydroxylate enzymatic (252-28B), poly(vinyl alcohol) (252-28A), or k-casein (252-30) by themselves as an adhesive resulted in low lap shear Max Force values. Comparing formulations containing k-casein 46.15 Wt. %, soy hydrosylate enzymatic 7.69 Wt. %, and either Organic Rice Protein, Wood Flour, or Cellulose Nano-fibers at 46.16 Wt. %, the Organic Rice Protein containing formulation (252-23F) exhibited consistently higher Max Force values the formulations containing Wood Flour (252-22F) or Cellulose Nano-fibers (252-21F) (see FIGS. 3 and 4).

Based on these results, additional lap shear testing of Organic Rice Protein/k-casein/soy hydrosylate enzymatic formulations (252-31) on Kraft paper was performed. Based on this additional testing, the formulation (252-31C) composed of 30.77 Wt. % Organic Rice Protein, 30.77 Wt. % k-casein, and 38.46 Wt. % soy hydrosylate enzymatic was selected for further investigation (see FIGS. 3 and 4).

Studies with formulation 252-36 (same as formulation 252-31C) were performed to determine whether the lap shear specimen drying time at ambient temperatures could be reduced below 48 hours (see Tables 5 and 6)

TABLE 5

| | Kraft Paper Substrate |
|---|---|
| | 252-36 |
| Wood Flour | |
| CNF | |
| Organic Rice Protein | 30.77 |
| Chitosan | |
| Casein | 30.77 |
| PVOH | |
| Starch, soluble | |
| Soy hydrosylate | 38.46 |

TABLE 6
Average Properties on Kraft Paper

| | | | | Energy to | |
|---|---|---|---|---|---|
| | | Max Force | | Break | |
| | State | (N) (dry) | | (dry) | |
| Time (hr) | (wet/dry) | Avg. | std. dev. | Avg. | std. dev. |
| 1 | dry | 6.458 | 1.284 | 0.347 | 0.111 |
| 2.25 | dry | 16.875 | 1.768 | 1.703 | 0.256 |
| 6 | dry | 183.333 | 84.988 | 197.707 | 191.830 |
| 24 | dry | 307.292 | 24.353 | 545.030 | 112.535 |
| 48 | dry | 300.000 | 27.176 | 490.107 | 151.691 |
| | | | | Energy to | |
| | | Max Force | | Break | |
| | State | (N) (wet) | | (wet) | |
| Time (hr) | (wet/dry) | Avg. | std. dev. | Avg. | std. dev. |
| 1 | wet | 5.417 | 0.589 | 0.670 | 0.510 |
| 2.25 | wet | 6.667 | 0.780 | 1.753 | 0.125 |
| 6 | wet | 11.250 | 2.041 | 4.757 | 0.484 |
| 24 | wet | 200.000 | 51.390 | 386.893 | 220.491 |
| 48 | wet | 228.958 | 20.106 | 427.977 | 112.377 |

For “dry” processed test strips, lap shear specimens were made as previously discussed. Drying time was started as soon as the specimen was clamped together.

For “wet” processed test strips, the following procedure applies: Prepare strips with a duct taped 1 inch square bonding area as previously discussed. Immerse both strips and strips with the duct taped bonding area in water at least 5 inches in depth. Remove a strip with the duct taped bonding area from the water, pat off excess water with a kimwipe, and spread the formulation evenly over the bonding area. Remove a strip from the water, pat off excess water with a kimwipe, and assemble the lap shear test specimen as previously described.

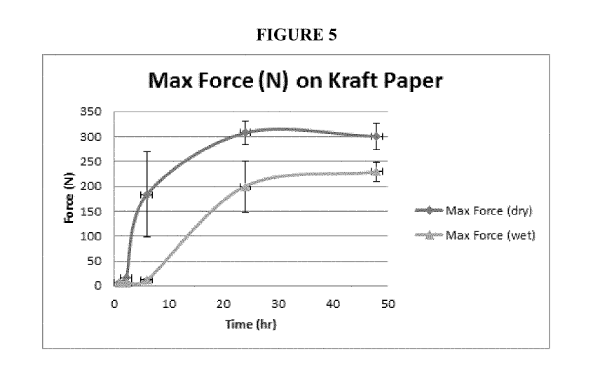

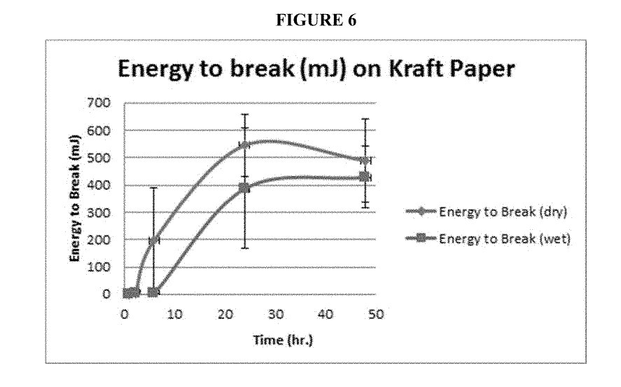

Drying time was started as soon as the specimen was clamped together. A drying time at ambient temperatures of approximately 24 hours appears to be sufficient for “dry” processed test specimens to achieve their largest Max Force and Energy to Break values. A drying time at ambient temperatures of approximately 24 hours also appears to be sufficient for “wet” processed test specimens to achieve their largest Max Force and Energy to Break values. Both “wet” Max Force and Energy to Break values are lower than the corresponding “dry” one but follow the same general time trend (see FIGS. 5 and 6).

Based on the above lap shear results, formulation 252-31C was selected for further investigation substituting alternative candidate materials for those in the initial formulation (Table 7).

TABLE 7

| | 252-39A | 252-39B | 252-39E | 252-39F |
|---|---|---|---|---|
| Organic Rice Protein | 30.77 | | 30.77 | 30.77 |
| Soy Protein, Isolated | | 30.77 | | |
| Casein | 30.77 | 30.77 | 30.77 | 30.77 |
| Soy hydrosylate | 38.46 | 38.46 | | |
| Yeast Extract | | | 38.46 | |
| Yeast Extract hydrosylate | | | | 38.46 |

Lap shear test specimens on Kraft paper and white oak wood veneer were prepared as previously described and allowed to dry at ambient temperatures for 24 hours.

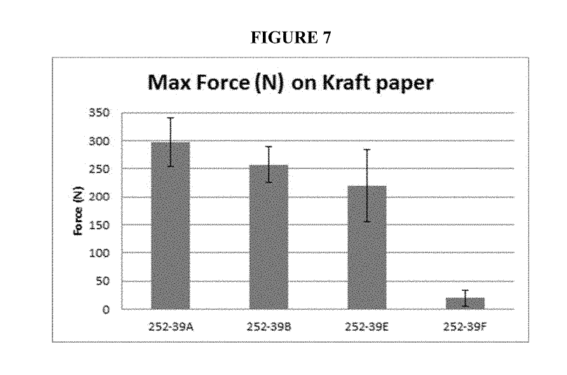

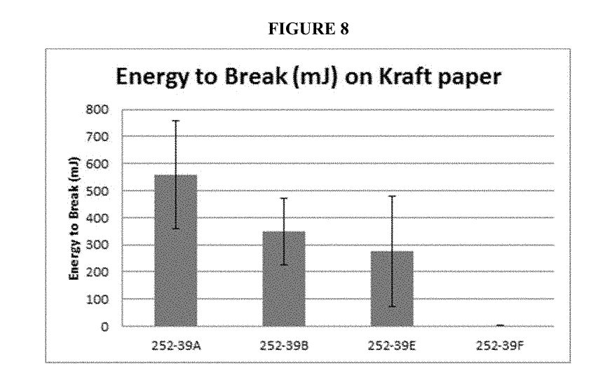

Formulation 252-39A (same as the original formulation 252-31C) resulted in Kraft paper lap shear test specimens exhibiting the highest Max Force and Energy to Break values (FIGS. 7 and 8).

TABLE 8
Average properties on Kraft Paper

| | Max Force | | Energy to | |
|---|---|---|---|---|
| | (N) | | Break (mJ) | |
| Name | Average | std. dev. | Average | std. dev. |
| 252-39A | 297.500 | 43.418 | 557.917 | 200.656 |
| 252-39B | 257.292 | 31.484 | 348.293 | 122.656 |
| 252-35E | 220.208 | 64.617 | 276.817 | 202.704 |
| 252-39F | 20.000 | 14.179 | 2.627 | 2.182 |

Oak Veneer:

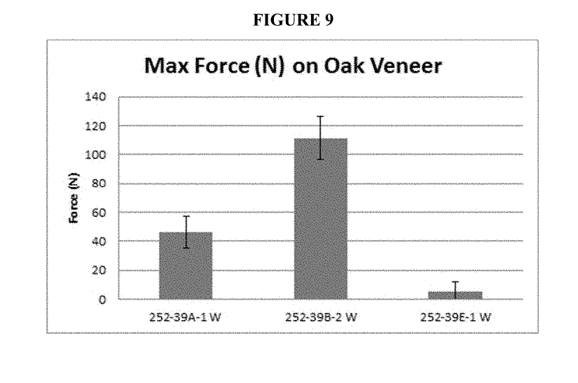

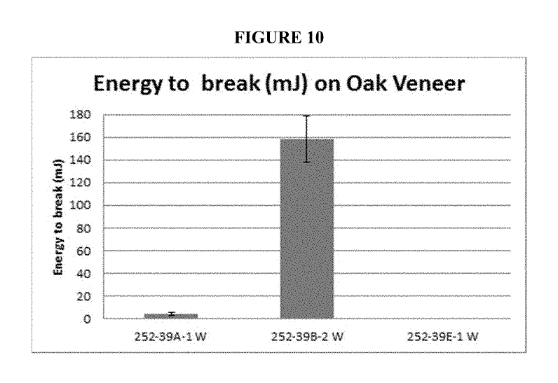

Formulation (252-39B-2 W) resulted in lap shear test specimens exhibiting the highest Max Force and Energy to Break values (FIGS. 9 and 10). This formulation replaced the Organic Rice Protein with Soy Protein Isolated.

TABLE 9
Average properties on Oak Veneer

| | Max Force | | Energy to | |
|---|---|---|---|---|
| | (N) | | Break (mJ) | |
| Name | Average | std. dev. | Average | std. dev. |
| 252-39A-1 W | 46.250 | 11.192 | 3.963 | 1.569 |
| 252-39B-2 W | 111.458 | 14.580 | 158.227 | 20.663 |
| 252-39E-1 W | 5.417 | 6.381 | 0.170 | 0.314 |

Additional modifications to the 252-31C formulation were investigated: replacing the Organic Rice Protein with Silk Fibroin (252-42C and 42D), the Soy Hydrosylate Enzymatic with Sericin (252-43B), and the addition of Microbial Transglutaminase (252-42B).

TABLE 10A

| | 252-42A | 252-42B | 252-42C | 252-42D | 252-42E | 252-42F |
|---|---|---|---|---|---|---|
| Organic Rice Protein | 30.77 | 28.58 | | | | |
| Silk Fibroin, 10 um | | | 30.77 | | 30.77 | |
| Casein | 30.77 | 28.57 | 30.77 | 30.77 | 30.77 | 30.77 |
| Silk Fibroin, 2 um | | | | 30.77 | | 30.77 |
| Egg Albumin | | | | | | |
| Sericin | | | | | 38.46 | 38.46 |
| Soy hydrosylate | 38.46 | 35.71 | 38.46 | 38.46 | | |
| Microbial | | 7.14 | | | | |
| Transglutaminase | | | | | | |

TABLE 10B

| | 252-43B |
|---|---|
| Organic Rice Protein | 30.77 |
| Silk Fibroin, 10 um | |
| Casein | 30.77 |
| Silk Fibroin, 2 um | |
| Sericin | |
| Soy hydrosylate | |
| Food glue | |

Lap shear test specimens on Kraft paper were prepared as previously described and allowed to dry at ambient temperatures for 24 hours.

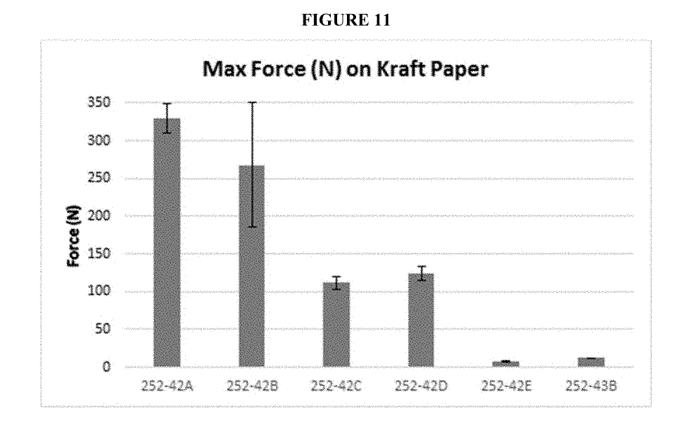

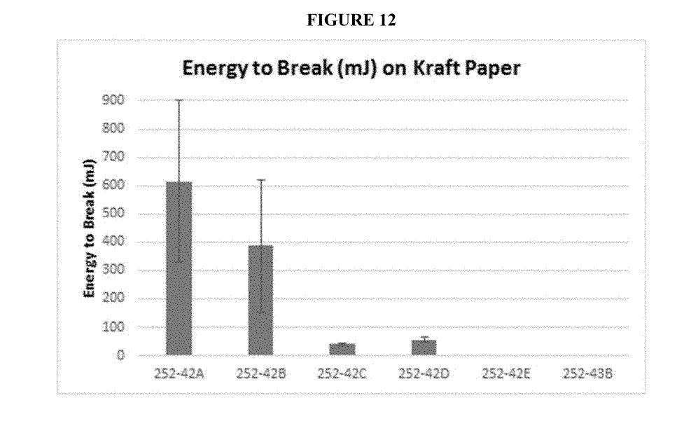

Formulation 252-42A (same as formulation 252-31C) resulted in Kraft paper lap shear test specimens exhibiting the highest Max Force and Energy to Break values (FIGS. 11 and 12).

TABLE 11
Average Properties on Kraft Paper

| | Max Force | | Energy to | |
|---|---|---|---|---|
| | (N) | | Break (mJ) | |
| Name | Average | std. dev | Average | std. dev. |
| 252-42A | 329.583 | 18.966 | 615.493 | 285.292 |
| 252.42B | 267.917 | 82.825 | 387.717 | 234.140 |
| 252.42C | 111.667 | 8.575 | 39.603 | 6.025 |
| 252-42D | 123.333 | 9.261 | 55.837 | 8.236 |
| 252-42E | 7.917 | 1.062 | 0.430 | 0.361 |
| 252-43B | 12.083 | 0.295 | 0.83 | 0.168 |

### INCORPORATION BY REFERENCE

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

### Other Embodiments

While particular embodiments of the disclosure have been illustrated and described, various other changes and modifications can be made without departing from the spirit and scope of the disclosure. The scope of the appended claims includes all such changes and modifications that are within the scope of this disclosure.

1. An adhesive composition comprising,
(a) a first component, wherein the first component
(1) is water insoluble and
(2) has a molecular weight of between 300 kDa and 1000 kDa, inclusive of the endpoints;
(b) a second component, wherein the second component
(1) is water insoluble and
(2) has a molecular weight of between 20 kDa and 35 kDa, inclusive of the endpoints; and
(c) a third component, wherein the third component
(1) is water soluble and
(2) has a molecular weight of between 1 Da and 19.9 kDa, inclusive of the endpoints;
wherein each of the first component, the second component, and the third component is present in a ratio and wherein the ratio is tunable for selective adhesion to at least one substrate.

2. The adhesive of claim 1, wherein the at least one substrate comprises an organic component.

3. The adhesive of claim 2, wherein the organic component comprises a fiber, a resin, a polymer, a composite or a tissue.

4. The adhesive of claim 3, wherein the fiber comprises a plant protein or an animal protein.

5-7. (canceled)

8. The adhesive of claim 3, wherein the polymer comprises a plant polymer or an animal polymer.

9-11. (canceled)

12. The adhesive of claim 3, wherein the tissue comprises a plant protein or an animal protein.

13-17. (canceled)

18. The adhesive of claim 2, wherein the organic component consists of carbon.

19-21. (canceled)

22. The adhesive of claim 1, wherein the at least one substrate comprises an inorganic component.

23. The adhesive of claim 22, wherein the inorganic component comprises a metal, a stone, a crystal, a chemical compound, a glass, an alloy, a composite or a polymer.

24. The adhesive of claim 23, wherein the chemical compound comprises a metalloid.

25-26. (canceled)

27. The adhesive of claim 23, wherein the polymer is not naturally-occurring.

28-29. (canceled)

30. The adhesive of claim 23, wherein the stone comprises marble, granite, limestone, slate, onyx, agate, sandstone, obsidian, lava stone, travertine, or a composite material.

31-32. (canceled)

33. The adhesive of claim 23, wherein the crystal comprises a quartz, a quartz composite, or a calcium carbonate.

34-36. (canceled)

37. The adhesive of claim 1, wherein the at least one substrate is wet.

38. The adhesive of claim 1, wherein the at least one substrate is fouled.

39. The adhesive of claim 1, wherein the at least one substrate is submerged in a liquid.

40. The adhesive of claim 39, wherein the liquid is water, seawater, a biological fluid, or a non-Neutonian fluid.

41-43. (canceled)

44. The adhesive of claim 1, wherein the at least one substrate is dry.

45. The adhesive of claim 1, wherein the at least one substrate is a first substrate and a second substrate.

46. The adhesive of claim 45, wherein a surface of the first substrate and a surface of the second substrate comprise an identical material.

47. The adhesive of claim 45, wherein a surface of the first substrate and a surface of the second substrate comprise a material having a comparable value of one or more characteristic selected from the group consisting of a volume, a mass, a surface area, a dimension, a density, a concentration, a capacitance, a resistance, a magnetism, an inductance, a ductility, a reflectiveness, a fragility, a brittleness, a charge, a conductivity, an impedance, a fluidity, a hardness, an irradiance, a malleability, a permeability, a porosity, a plasticity, an elasticity, a deformability, a fibrosity, a solubility, a viscosity, a level of fouling, a level of degradation, a smoothness, a uniformity of composition, a uniformity of characteristic, and a composition.

48. The adhesive of claim 45, wherein a surface of the first substrate and a surface of the second substrate do not comprise an identical material.

49. The adhesive of claim 45, wherein a surface of the first substrate and a surface of the second substrate do not comprise a material having a comparable value of one or more characteristic selected from the group consisting of a volume, a mass, a surface area, a dimension, a density, a concentration, a capacitance, a resistance, a magnetism, an inductance, a ductility, a reflectiveness, a fragility, a brittleness, a charge, a conductivity, an impedance, a fluidity, a hardness, an irradiance, a malleability, a permeability, a porosity, a plasticity, an elasticity, a deformability, a fibrosity, a solubility, a viscosity, a level of fouling, a level of degradation, a smoothness, a uniformity of composition, a uniformity of characteristic, and a composition.

50-59. (canceled)

60. The adhesive of claim 1, wherein the first component is a kinetic modifier.

62. The adhesive of claim 1, wherein the first component comprises a protein, a fiber, a resin, an extract, a distillate or a polymer.

63-64. (canceled)

65. The adhesive of claim 1, wherein the second component is a thermodynamic modifier.

66. The adhesive of claim 1, wherein the second component comprises a protein, a distillate, a resin, a starch, a polysaccharide or an extract.

67-68. (canceled)

69. The adhesive of claim 1, wherein the third component is an interstitial modifier.

70. The adhesive of claim 1, wherein the third component comprises a protein, an enzyme, a hydrosylate, a distillate or an extract.

71-75. (canceled)

76. The adhesive of claim 1, wherein the ratio of the first component:second component is between 1:10 and 10:1, wherein the ratio of the second component:third component is between 1:10 and 10:1, and wherein the ratio of the first component:third component is between 1:10 and 10:1.

77-82. (canceled)
